(19) United States
(12) Patent Application Publication
(10) Pub. No.: US 2017/0035633 A1
(43) Pub. Date: Feb. 9, 2017

(54) AUTOMATED VARIABLE BED TO WHEELCHAIR SYSTEM

(71) Applicant: CareChair, Waterloo (CA)

(72) Inventors: Ali Amin, Calgary (CA); Sanjith Kumar Chandran, Waterloo (CA); Oasis Vali, Brampton (CA); Surya Lakshmivarahan, Brampton (CA); Gleeson Kathirgamanathan, Welland (CA)

(21) Appl. No.: 15/231,679

(22) Filed: Aug. 8, 2016

Related U.S. Application Data
(60) Provisional application No. 62/202,633, filed on Aug. 7, 2015.

(30) Foreign Application Priority Data
Mar. 14, 2016 (CA) 2923659

(51) Int. Cl. A61G 7/018; A61G 7/015; A61G 7/012; A61G 5/00; A61G 5/10

(52) U.S. Cl. CPC A61G 7/018; A61G 5/006; A61G 5/104; A61G 5/1067; A61G 7/012; A61G 7/015

(57) ABSTRACT

Various embodiments are described herein for a system and a method for an automated wheelchair and bed system that transforms between wheelchair and bed positions. In one embodiment, an automated wheelchair and bed system comprises a chassis; a back mechanism assembly pivotally coupled to the chassis; a set rest assembly coupled to the chassis; a leg mechanism assembly pivotally coupled to the chassis; and a sliding base assembly slidingly coupled to the chassis, the sliding base assembly comprising a sliding base mechanism that moves away from a rear portion of the system when the system transitions from a wheelchair position to a bed position and moves towards the rear portion of the system when the system transitions from bed position to wheelchair position. In an alternative embodiment, an actuator is used to move the sliding base assembly and change the height of the system in chair mode or bed mode.

### CROSS-REFERENCE TO RELATED APPLICATION

This application claims the benefit of U.S. Provisional Patent Application No. 62/202,633 filed on Aug. 7, 2015 and Canadian Patent Application No. 2,923,659 filed on Mar. 14, 2015; the entire contents of Patent Application No. 62/202,633 and Canadian Patent Application No. 2,923,659 are hereby incorporated by reference.

### FIELD

Various embodiments are described herein that generally relate to a medical device that transforms between a wheelchair and a bed and has improved stability.

### BACKGROUND

When an individual is confined to a wheelchair or is bedridden, they are forced to rely on nurses or caregivers for assistance. During a typical shift, nurses and caregivers move patients 5 to 10 times between a wheelchair and a bed. Due to the significant associated physical exertion, nurses and caregivers often injure themselves and actually account for more than 60% of all work related musculoskeletal disorders (Nelson and Baptiste). In fact, nurses and caregivers suffer 14 times as many musculoskeletal disorders in their line of work compared to manual laborers (Waters).

Currently, hospitals and nursing homes purchase cranes to assist with moving patients. However, in addition to requiring caregivers to be present at all times, these cranes are uncomfortable and present a risk of injury to the patient. Other solutions involving ‘transforming wheelchairs’ or ‘reclining stretchers’ have been implemented; however, they either require manual operation, external peripherals or are unable to remain stable when in bed form.

A system that may reduce the amount of assistance required in transporting an individual from a bed to a wheelchair or vice versa may reduce the occurrence of injury to both care provider and the individual and may also reduce the cost of care. Such a system may also empower individuals by helping to restore their independence.

### SUMMARY OF VARIOUS EMBODIMENTS

In a broad aspect, at least one embodiment described herein provides an automated wheelchair and bed system that comprises a chassis; a back mechanism assembly coupled to the chassis; a set rest assembly coupled to the chassis; a leg mechanism assembly coupled to the chassis; and a sliding base assembly slidingly coupled to the chassis, the sliding base assembly comprising a sliding base mechanism that moves away from a rear portion of the system when the system transitions from a wheelchair position to a bed position and moves towards the rear portion of the system when the system transitions from bed position to wheelchair position.

In at least one embodiment, the system further comprises a controller for automatically controlling the transition of the system between the wheelchair and bed positions; an input interface coupled to the controller for receiving inputs for controlling the motion of at least one of the back mechanism assembly, the leg mechanism assembly and the sliding base assembly; and actuators coupled to the controller and the back mechanism assembly, the leg mechanism assembly and the sliding base assembly to receive at least one control signal from the controller to move at least one of the back mechanism assembly, the leg mechanism assembly and the sliding base assembly.

In at least one embodiment, the system comprises a back mechanism actuator that is pivotally coupled to the back mechanism assembly and the chassis; a sliding base actuator that is pivotally coupled to the sliding base assembly and the chassis; and a leg mechanism actuator that is pivotally coupled to the leg mechanism assembly and the chassis.

In at least one embodiment, the sliding base mechanism comprises an upper portion that is rotatably coupled to an arm of the sliding base actuator; and a lower portion that is rotatably coupled to the arm of the sliding base actuator; wherein when the arm of the sliding base actuator is extended when the system transitions to the bed position, the upper and lower portions rotate to a substantially vertical position where an upper end of the upper portion supports a portion of the back mechanism assembly and a lower end of the lower portion rests on the floor underneath the system to provide support for the system.

In at least one embodiment, the sliding base mechanism further comprises a horizontal shaft that is slidably received in an aperture at an end of the arm of the sliding base actuator; a first pair of linkages that are pivotally coupled to the horizontal shaft and are pivotally coupled to the upper portion of the sliding base mechanism; and a second pair of linkages that are pivotally coupled to the horizontal shaft and are pivotally coupled to the lower portion of the sliding base mechanism, wherein when the arm of the sliding base actuator is extended to transition the system to the bed position, the horizontal shaft moves away from the rear of the system and the upper and lower linkages rotate to move the upper and lower portions of the sliding base mechanism to a substantially vertical position.

In at least one embodiment, the upper portion of the sliding base mechanism comprises a first set of posts with grooves and the first set of linkages are pivotally coupled to sliders that are fixed to the first set of posts and the lower portion of the sliding base mechanism comprises a second set of posts with grooves and the second set of linkages are pivotally coupled to sliders that are fixed to the second set of posts.

In at least one embodiment, the sliding base mechanism further comprises first and second set of rails that are spaced apart, have grooves and are coupled to the chassis; and opposing ends of the horizontal shaft are coupled to sliders that slidingly engage the grooves of the first and second rails.

In at least one embodiment, the sliding base mechanism further comprises a horizontal support member disposed between the upper and lower portions of the sliding base mechanism and between the first and second rails to provide additional structural support.

In at least one embodiment, the sliding base mechanism comprises a base plate, the upper and lower portions of the sliding base mechanism are pivotally coupled to the base plate, and the horizontal support member is attached to the base plate.

In at least one embodiment, the lower portion of the sliding base mechanism comprises caster wheels for making contact with the floor.

In another aspect, in at least one embodiments, the sliding base assembly comprises a first base member that is slidably received within a lower portion of the chassis and has a retracted position during chair mode and moves to an extended position during bed mode or when the system is increased in height.

In at least one embodiment, the system further comprises a height adjustment assembly, and at least one actuator that couples the height adjustment assembly with the sliding base assembly, the at least one actuator being configured to sequentially control the sliding base assembly and the height adjustment assembly.

In at least one embodiment, the at least one actuator is configured to move the sliding base assembly to an extended position and then increase the height of the height adjustment assembly or to decrease the height of the height adjustment assembly and then retract the sliding base assembly into a retracted position.

In at least one embodiment, the height adjustment assembly comprises a plurality of members with proximal ends that are pivotally coupled to a proximal upper portion of the chassis and a proximal lower portion of the chassis and distal ends that are slidably coupled to a distal upper portion of the chassis and a lower distal portion of the chassis.

In at least one embodiment, the height adjustment assembly comprises a first pair of members and a second pair of members, the first pair of members being pivotally coupled at their midpoint to form a first scissor mechanism disposed at one side of the system and the second pair of members being pivotally coupled at their midpoint to form a second scissor mechanism disposed at a second opposite side of the system.

In at least one embodiment, the at least one actuator is pivotally coupled to a bar that is disposed between and coupled to the first and second scissor mechanisms above the midpoint of rearward facing members that form one half of each scissor mechanism.

In at least one embodiment, the height adjustment assembly comprises a pair of rollers coupled to the distal ends of the members that are slidably coupled to the distal upper portion of the chassis where there is a downward facing groove and slidably coupled to the distal lower portion of the chassis where there is an upward facing groove, the grooves being configured to constrain the movement of the rollers in a linear fashion.

In at least one embodiment, the system further comprises a seat actuator that is pivotally coupled to an upper portion of the chassis for adjusting the angle of the seat rest.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1A and 1B show a front and a rear isometric view, respectively, of an example embodiment of a wheelchair and bed system in an upright chair position.

FIGS. 2A and 2B show a side and cross-sectional side view, respectively, of the wheelchair and bed system in the upright chair position.

FIG. 3 is a rear view of the wheelchair and bed system in the upright chair position.

FIG. 4 is a front isometric view of the wheelchair and bed system in a reclined bed position.

FIGS. 5A and 5B show side and cross-sectional side views, respectively, of the wheelchair and bed system in the reclined bed position.

FIG. 6 is a rear view of the wheelchair and bed system in the reclined bed position.

FIG. 7A is an isometric view of an example embodiment of a mounted automated stabilizing mechanism for the wheelchair and bed system.

FIG. 7B is an isometric view of an example embodiment of mounting carriages that are used to move the back mechanism assembly of the wheelchair and bed system.

FIG. 7C is an isometric view of the automated stabilizing mechanism for the wheelchair and bed system.

FIG. 7D is an isometric exploded view of the automated stabilizing mechanism.

FIG. 7E is a partial cross-sectional side view of the automated stabilizing system when the wheelchair and bed system is in the chair position.

FIG. 7F is another partial cross-sectional side view of the automated stabilizing system when the wheelchair and bed system is in the chair position.

FIG. 7G is a partial cross-sectional side view of the automated stabilizing system in transition when the wheelchair and bed system is transitioning to the bed position.

FIG. 7H is a partial cross-sectional side view of the automated stabilizing system when it is fully extended and the wheelchair and bed system has transitioned to the bed position.

FIG. 8A is an exploded view of an example embodiment of a back assembly that is used with the wheelchair and bed system.

FIG. 88 shows an isometric view, a front view, a top view, and a side view of the back assembly along with example dimensions.

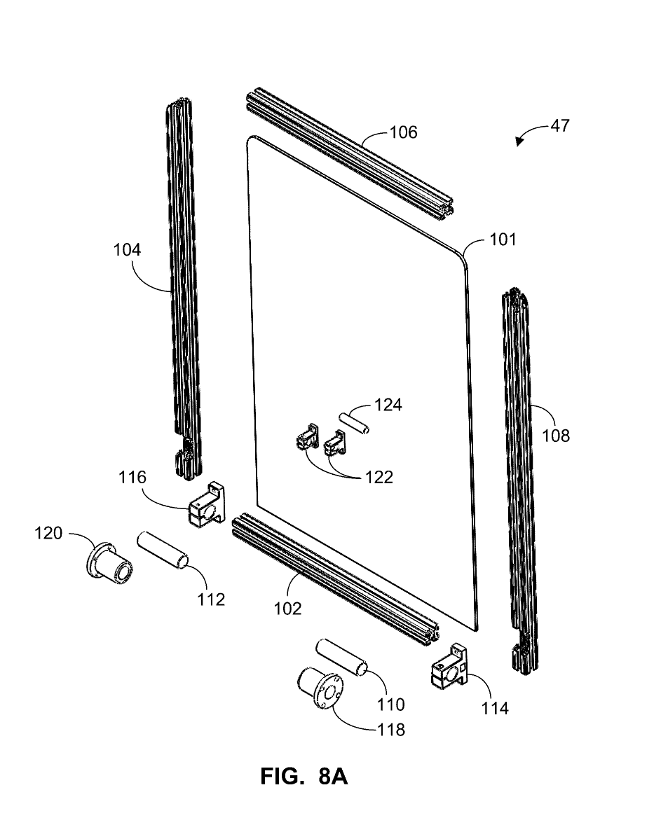

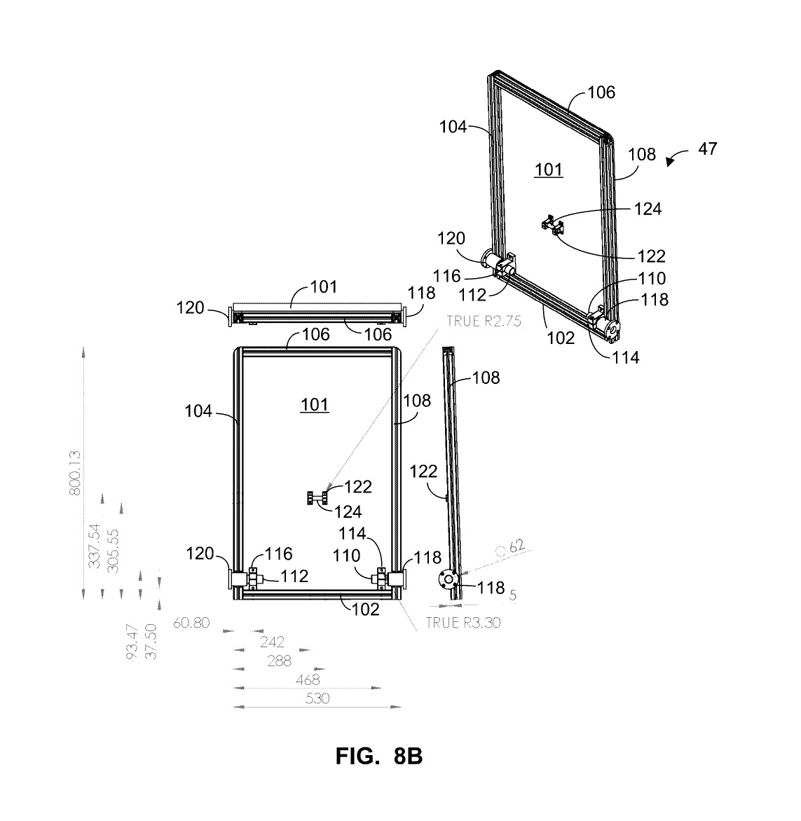

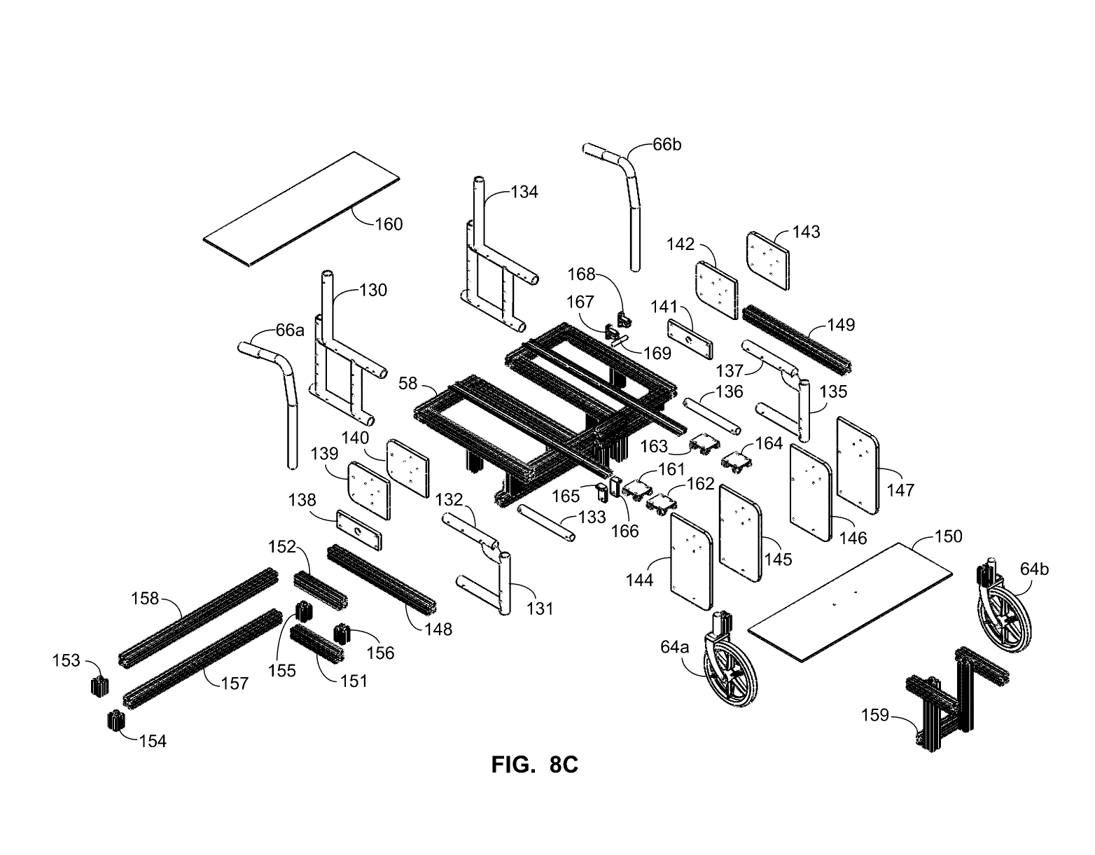

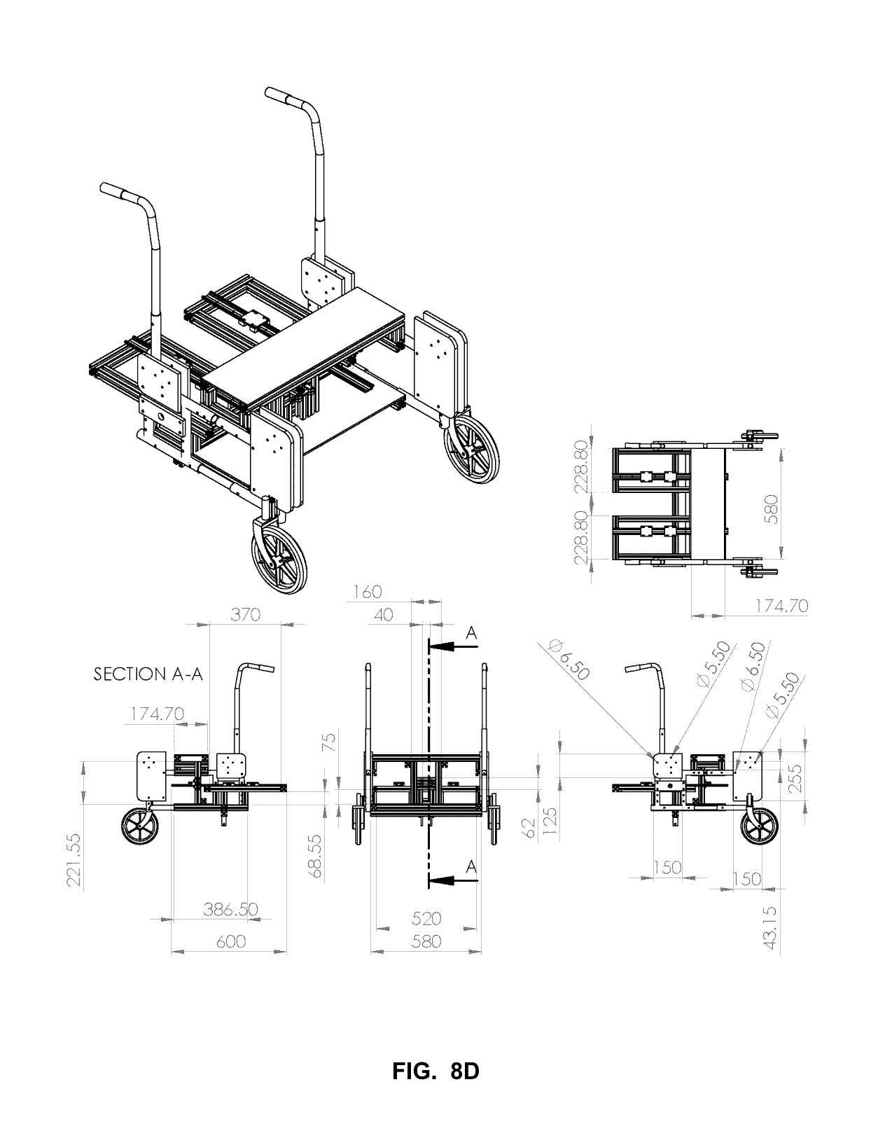

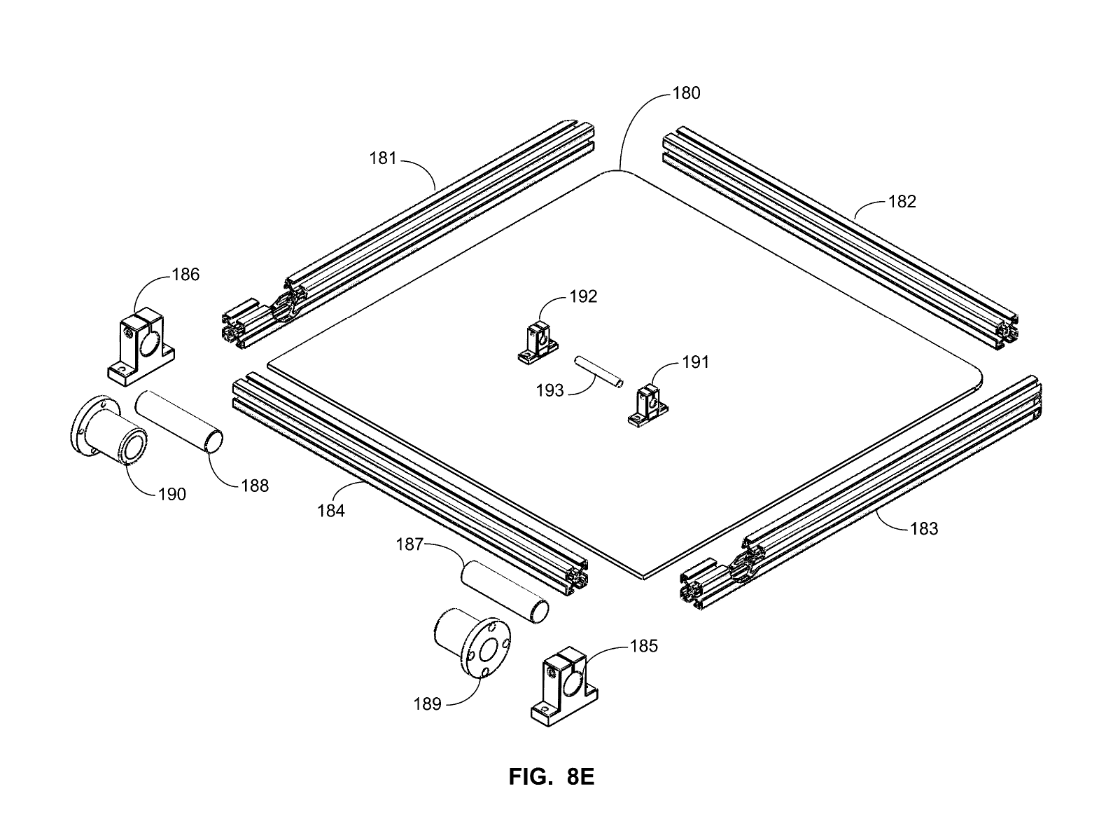

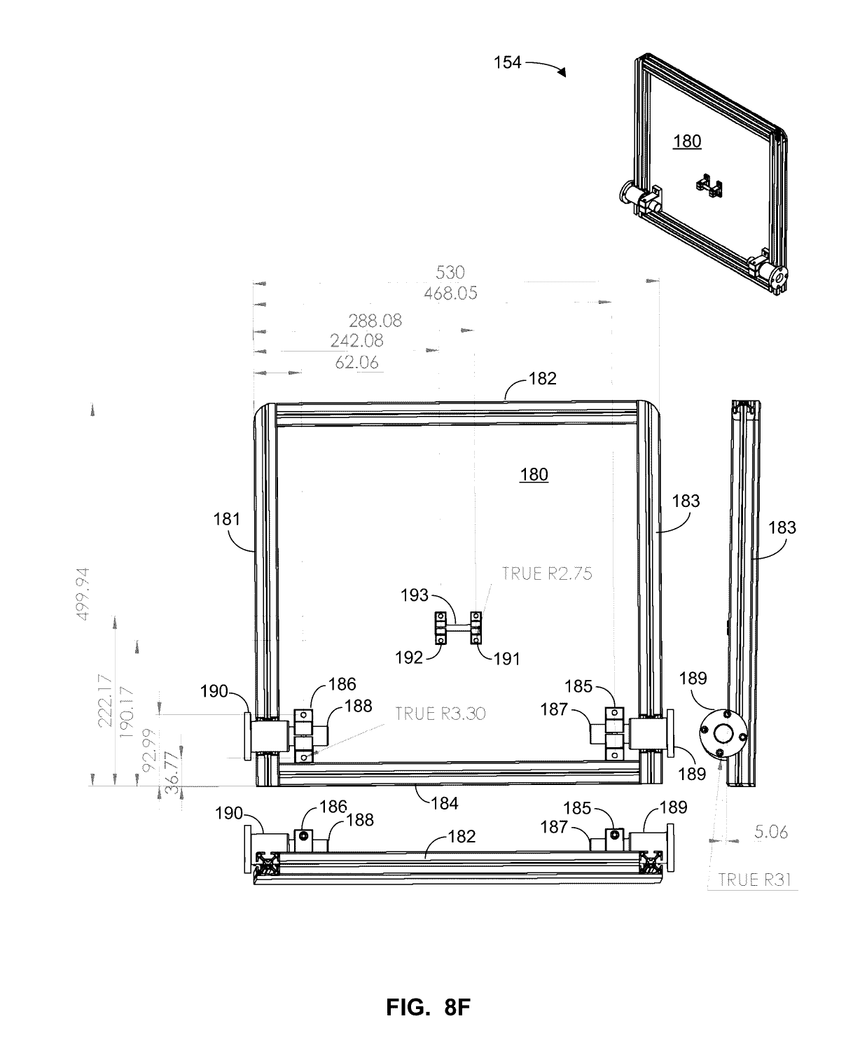

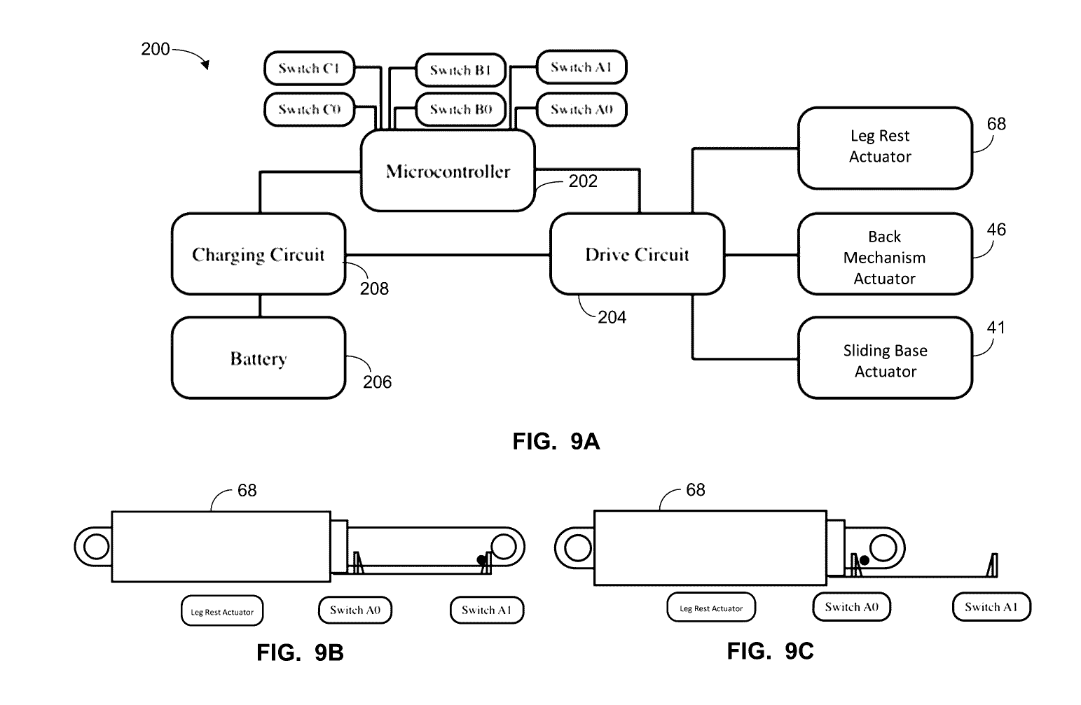

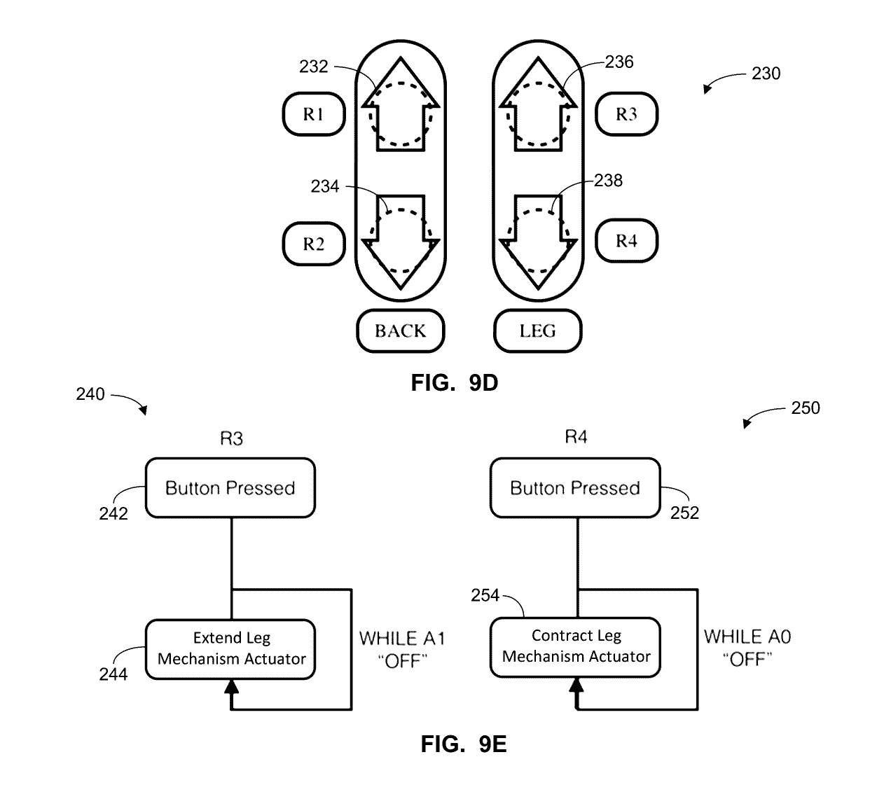

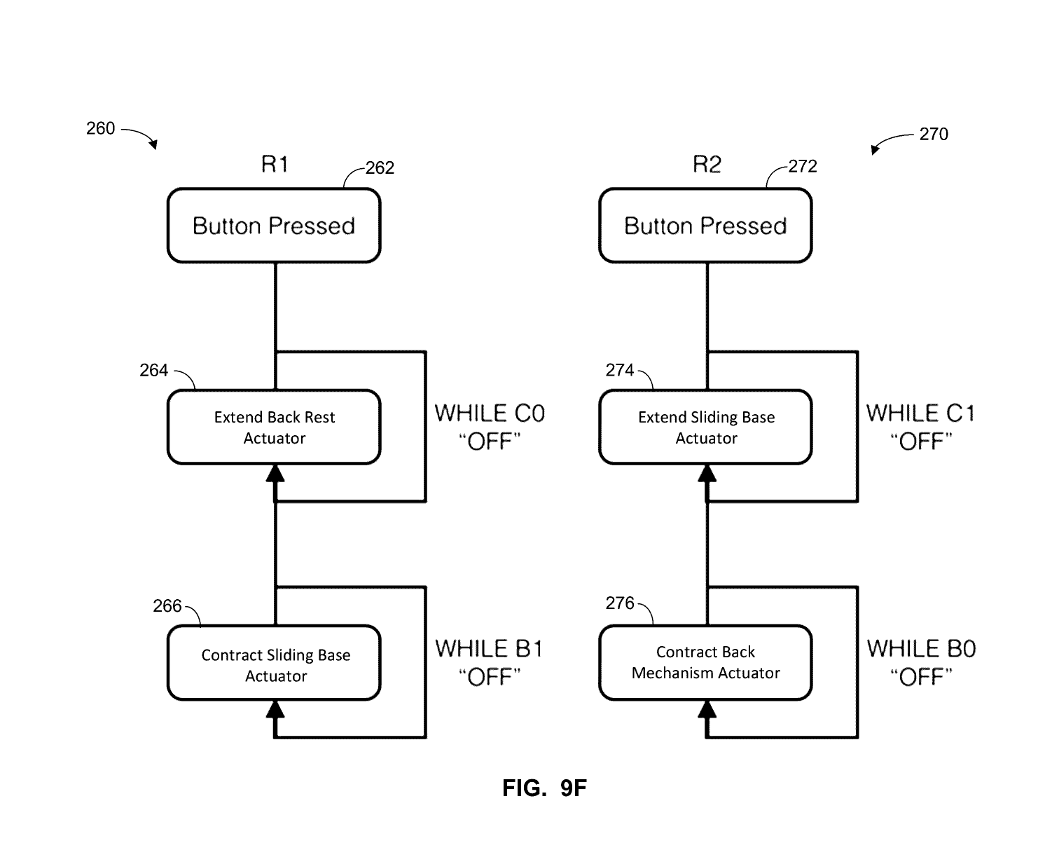

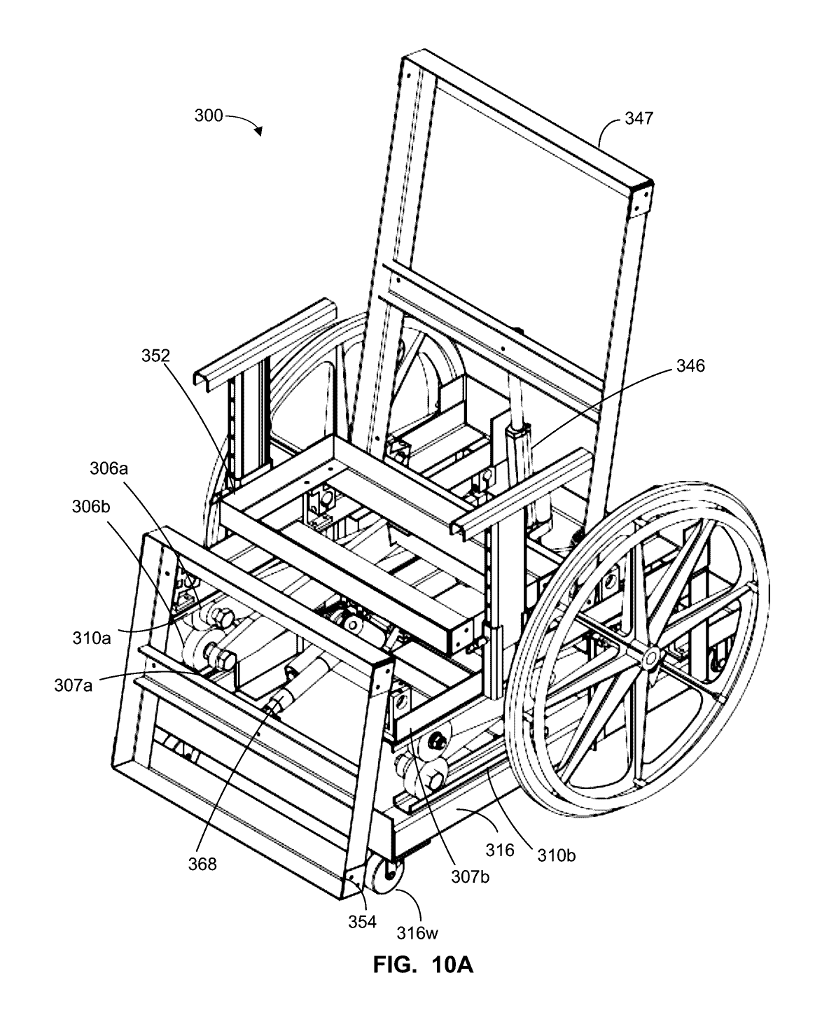

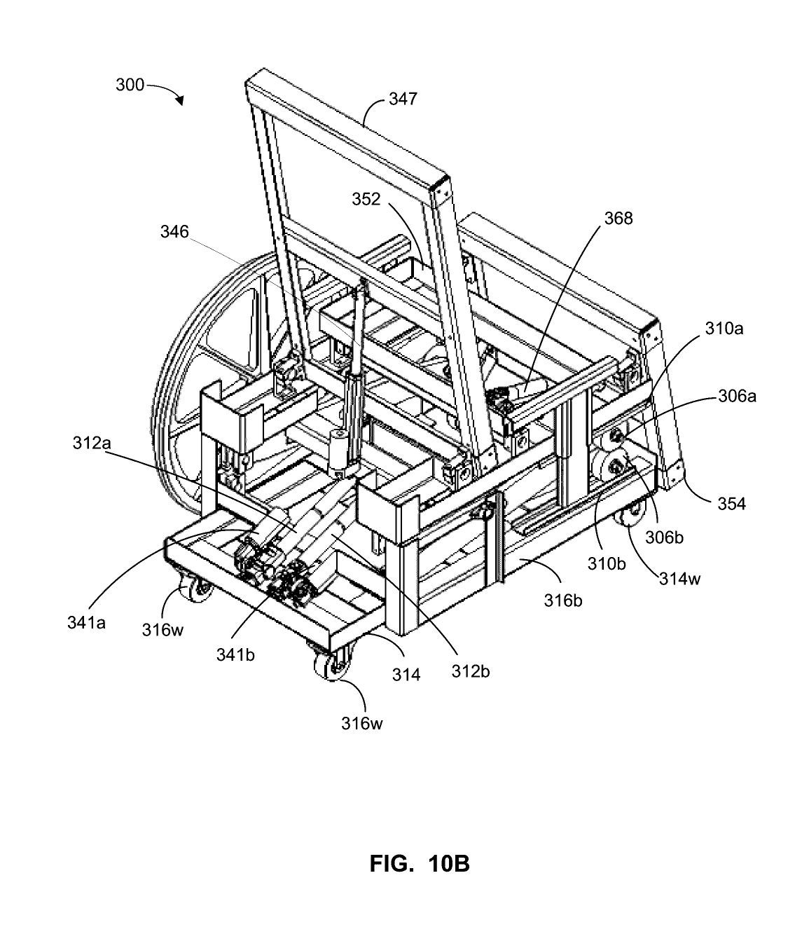

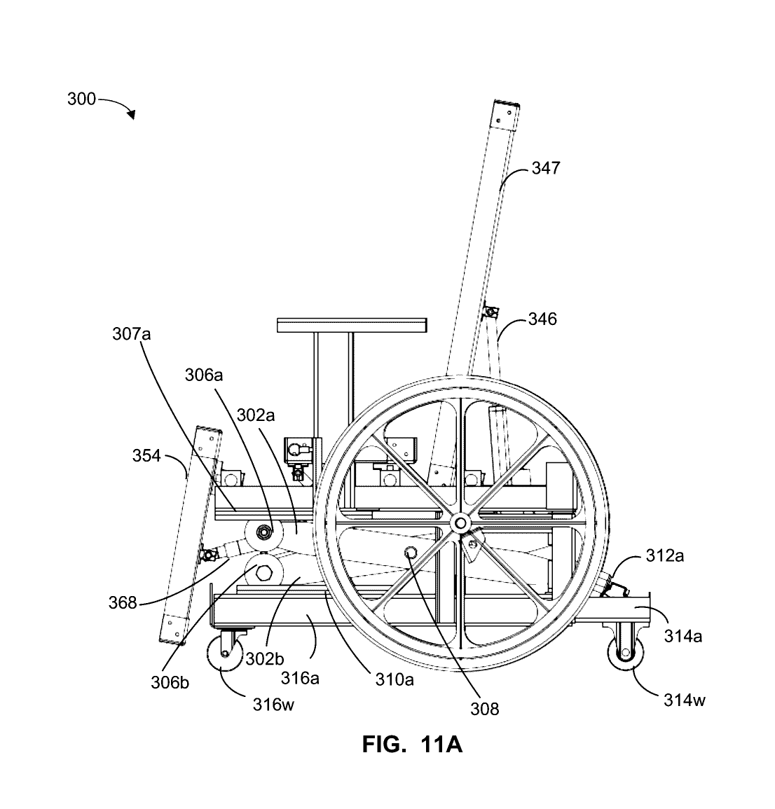

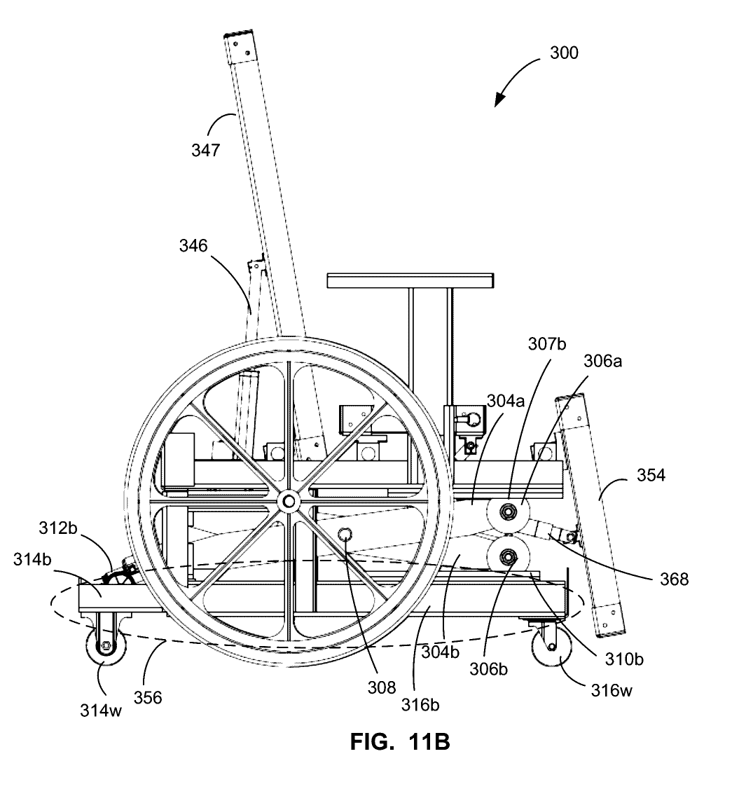

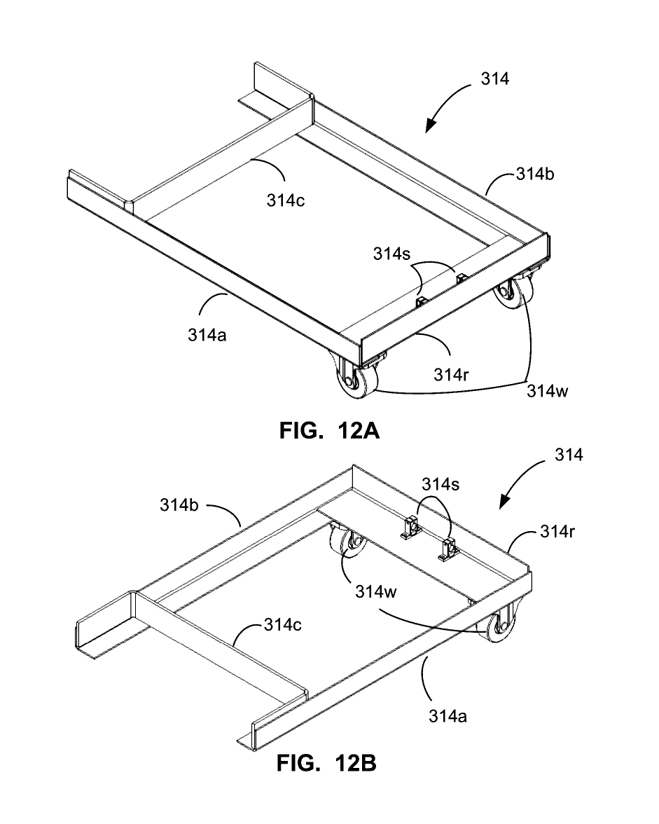

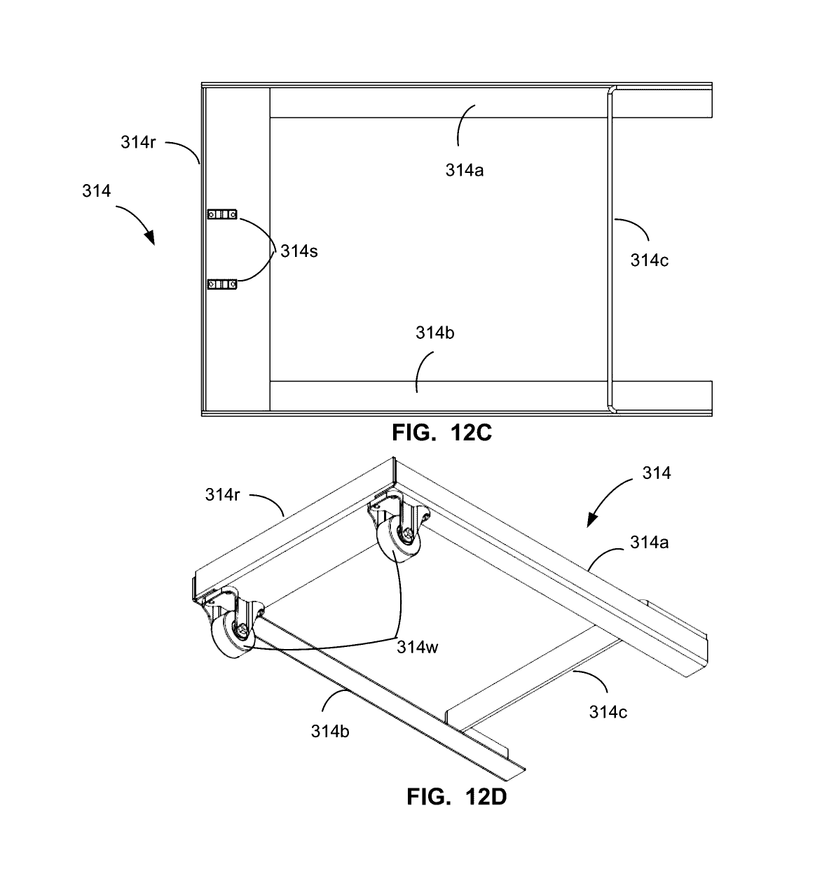

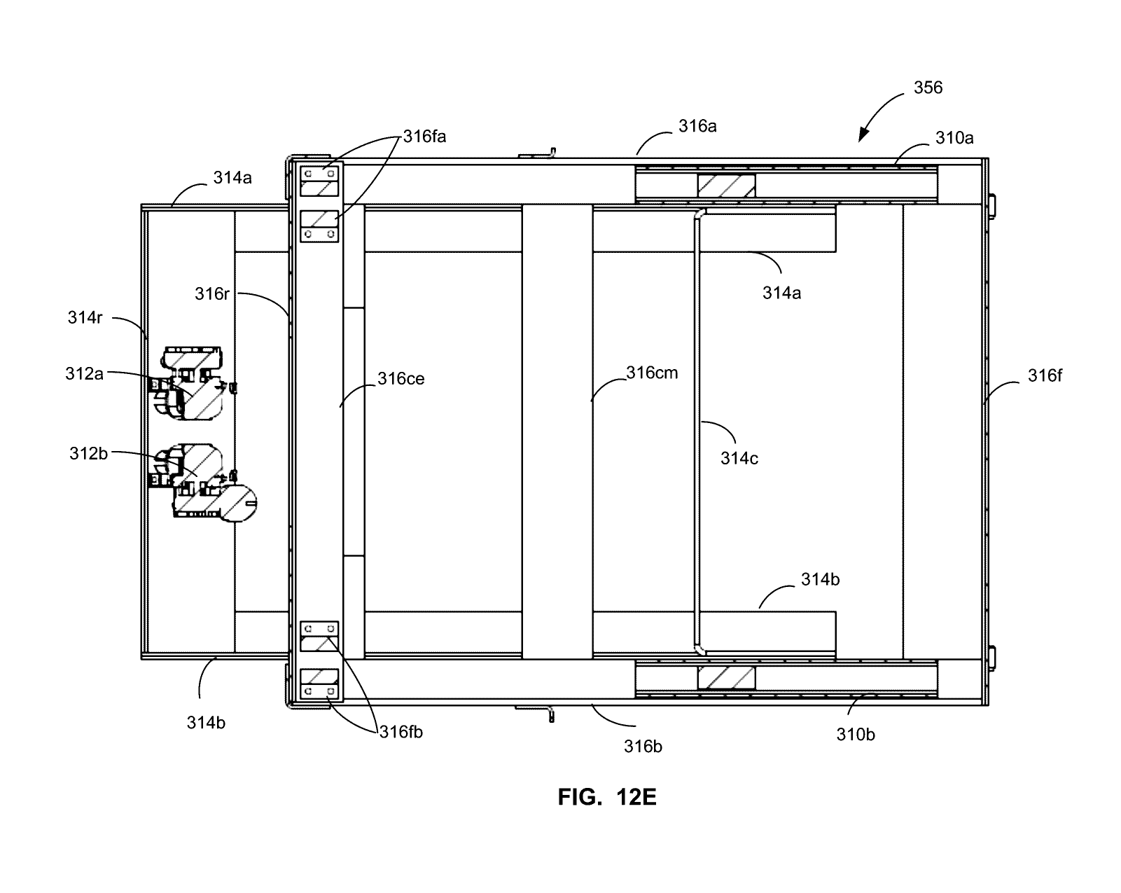

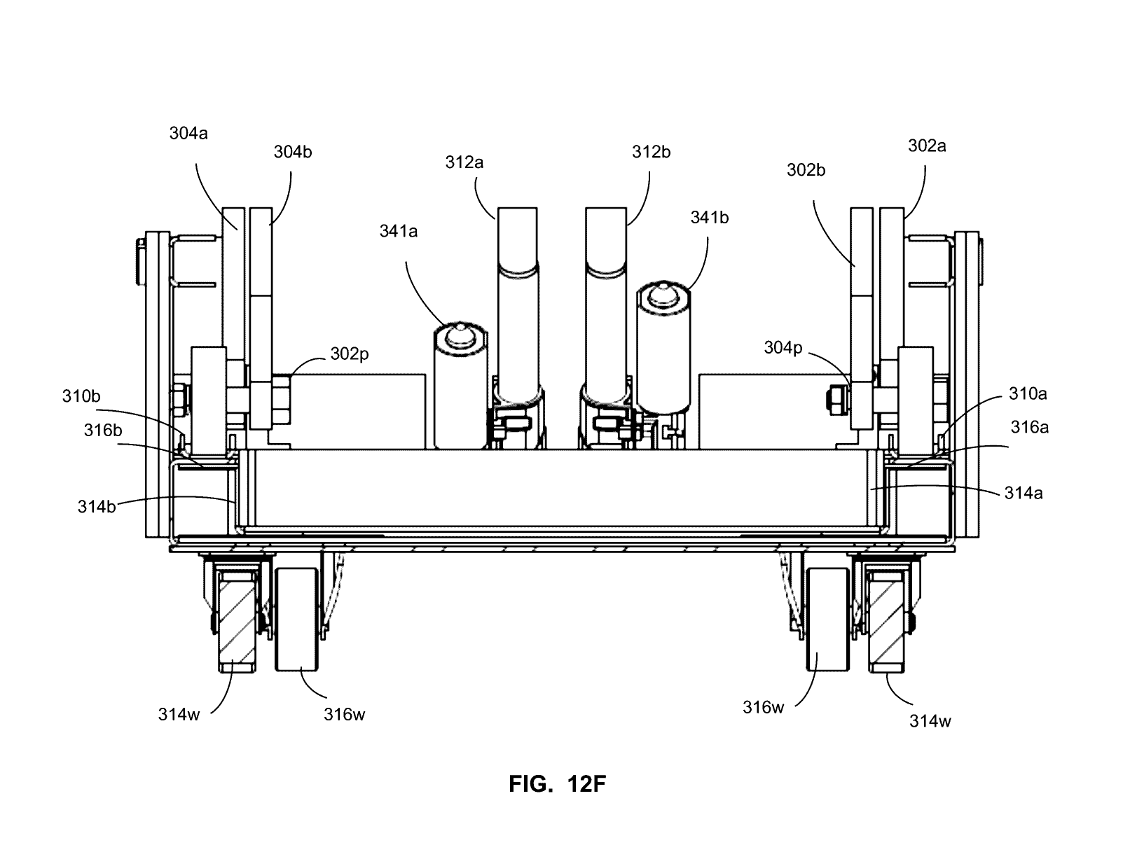

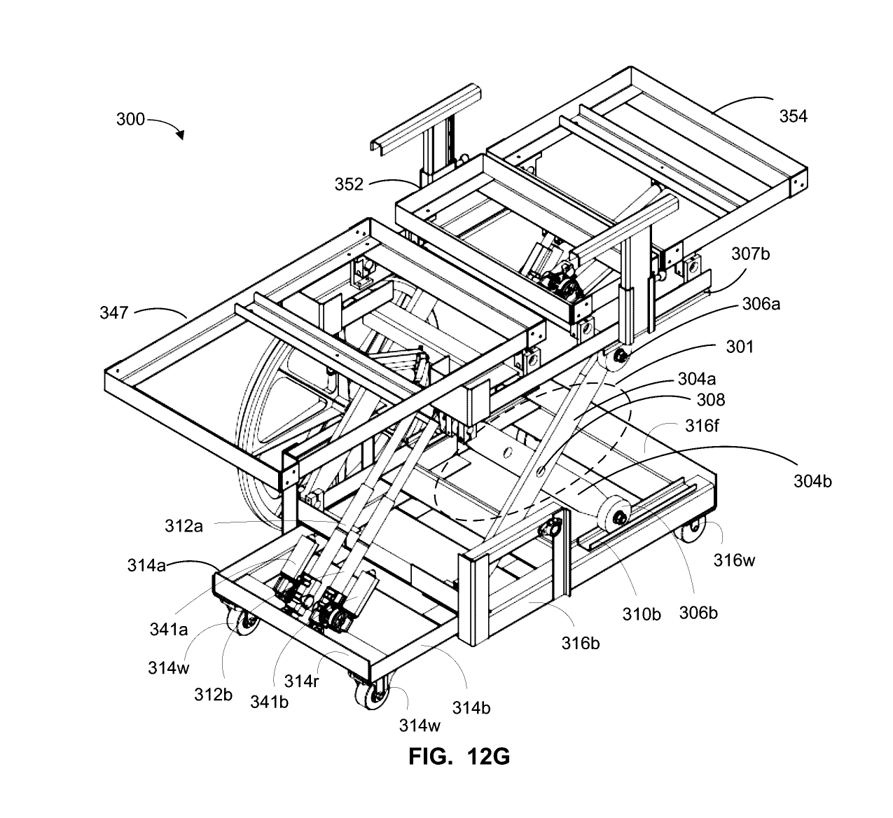

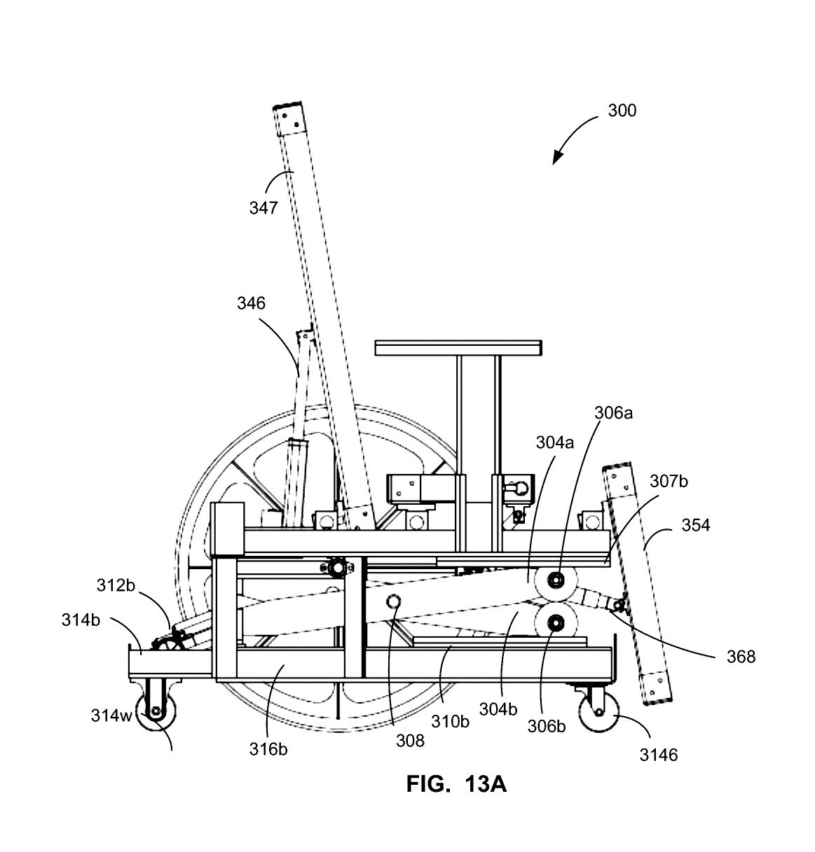

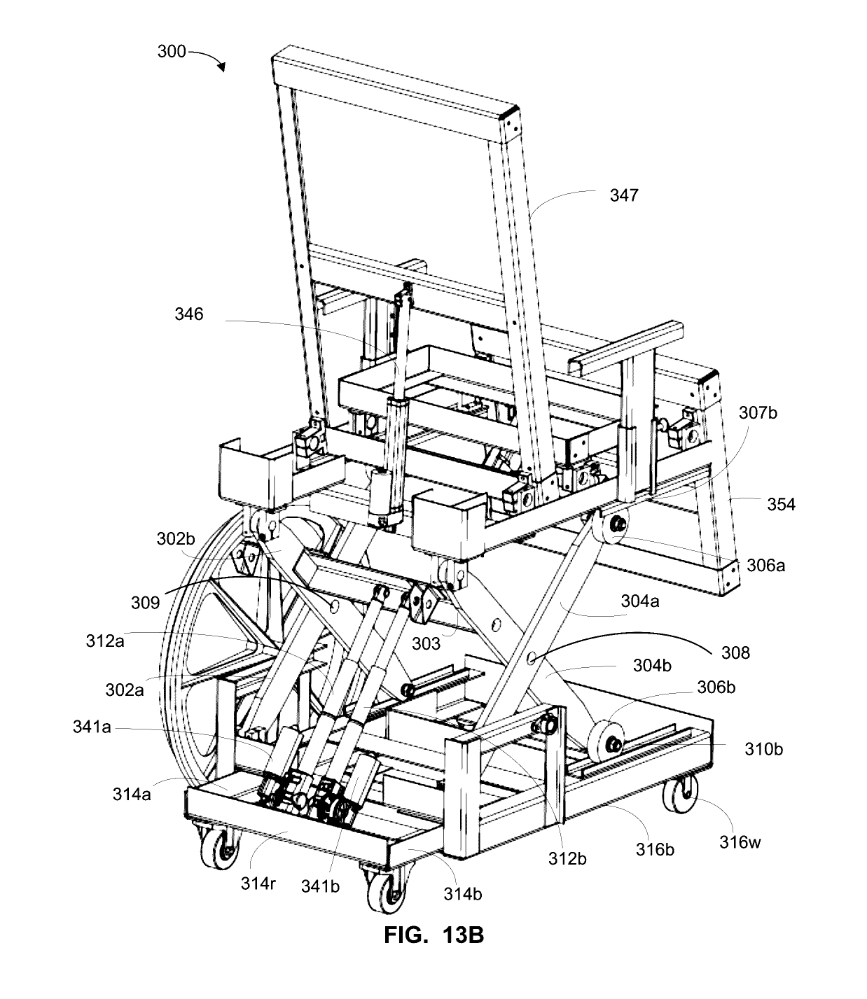

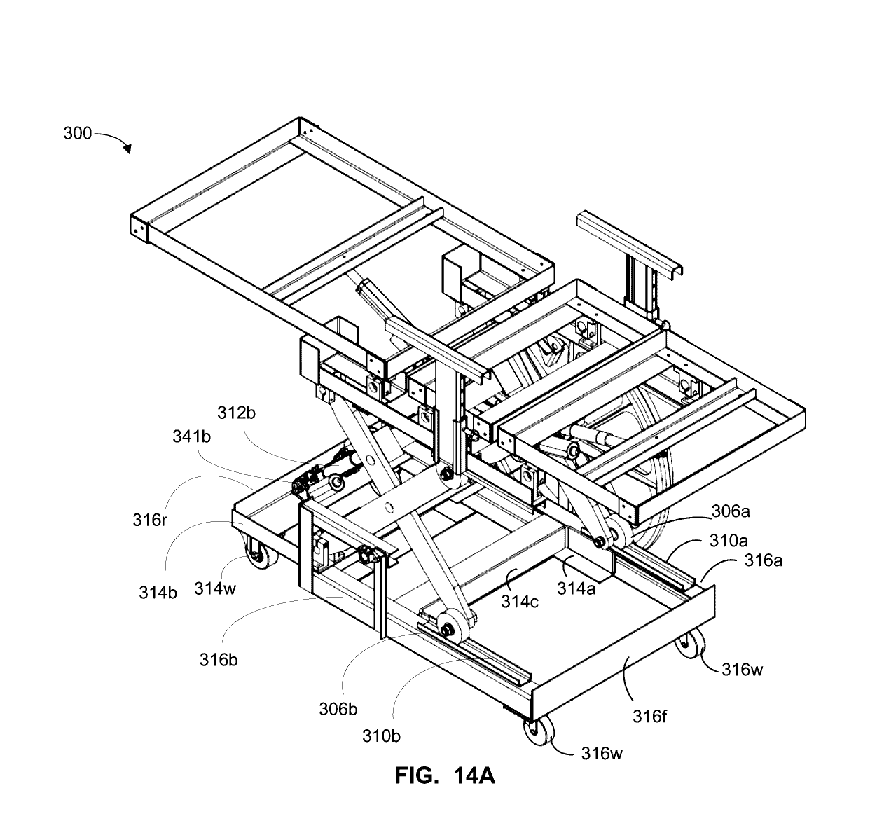

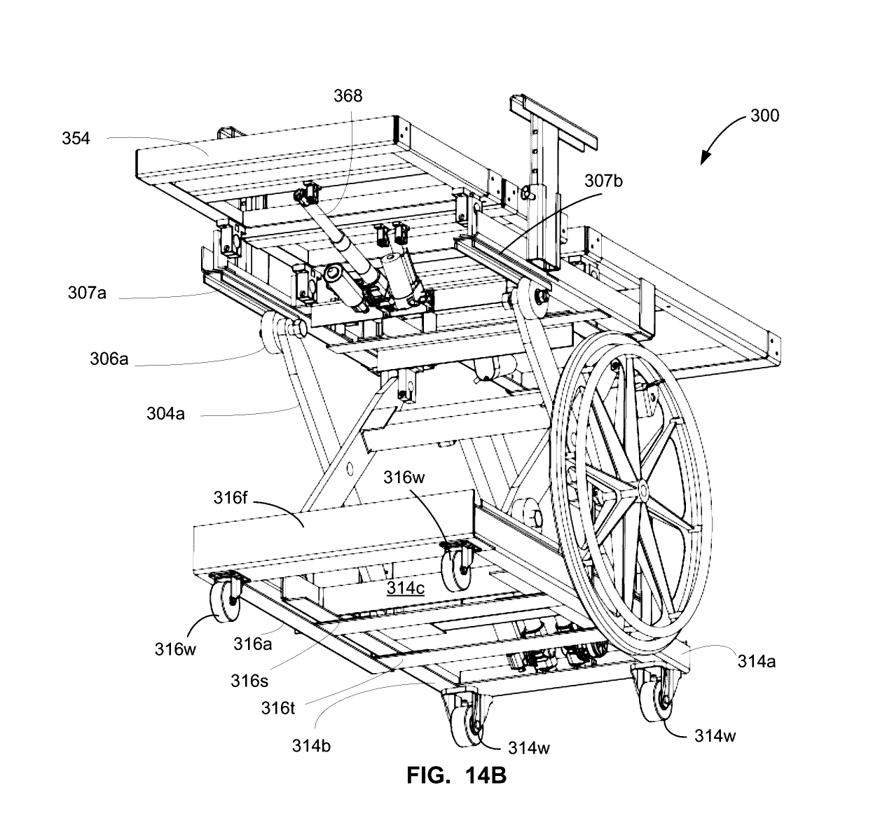

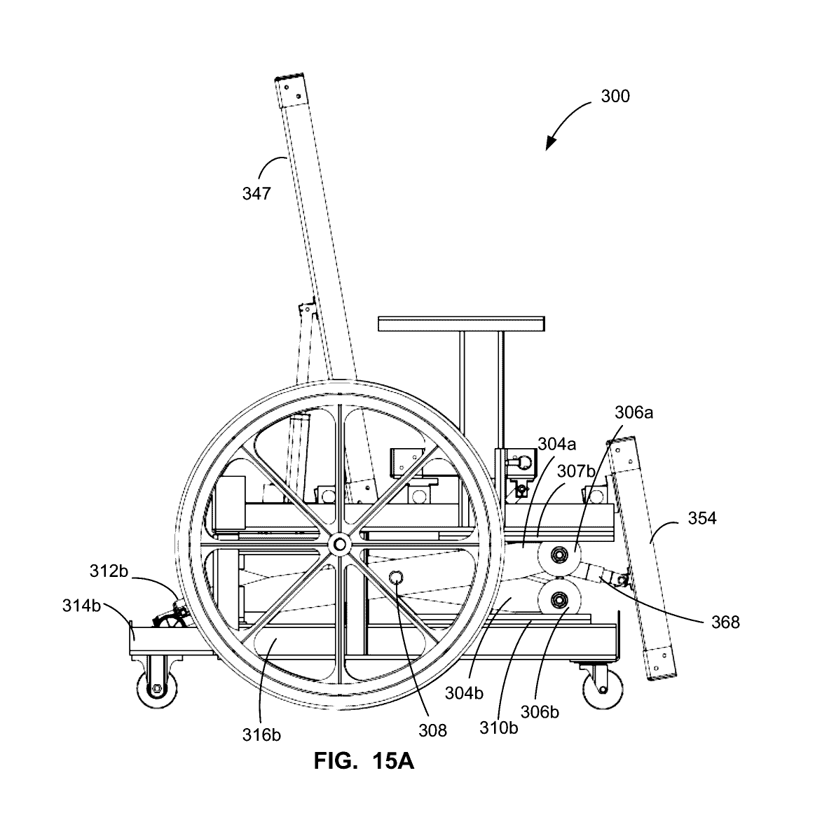

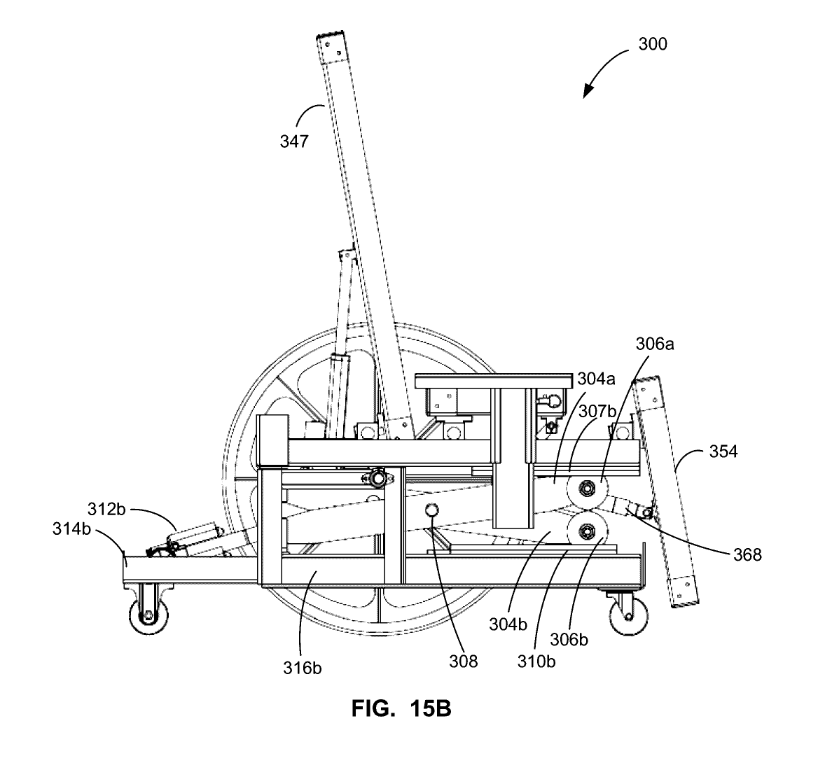

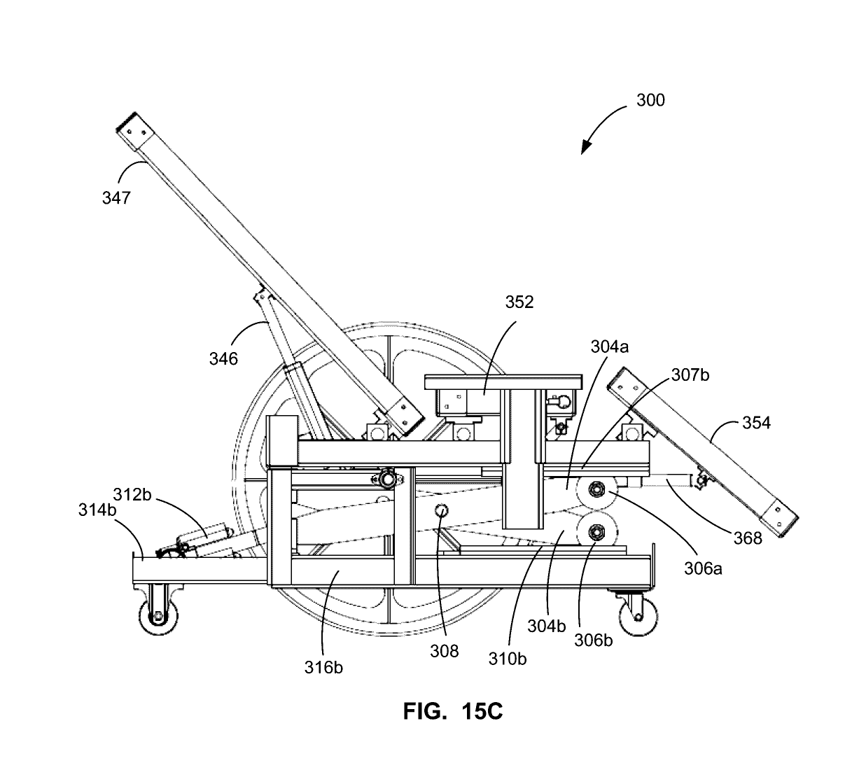

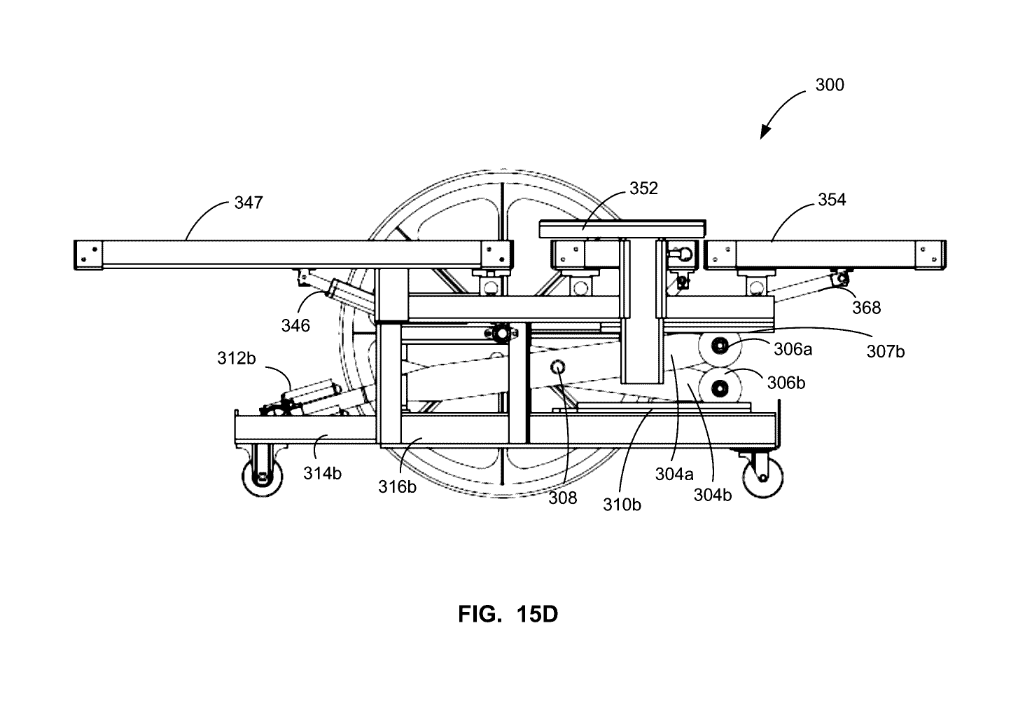

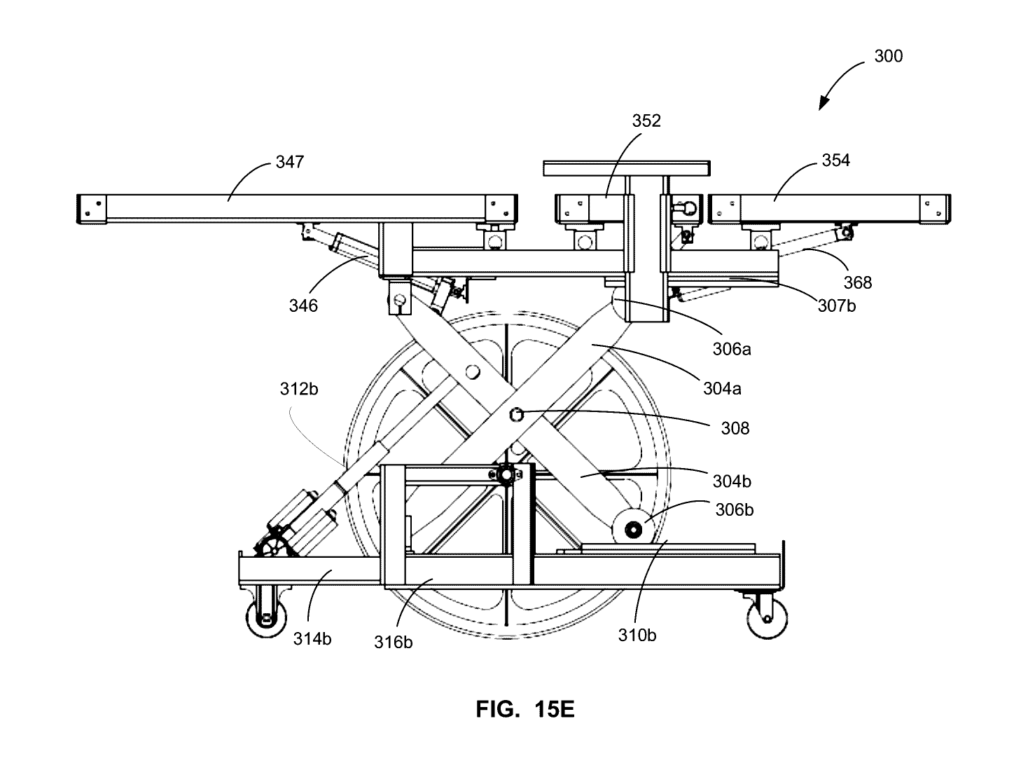

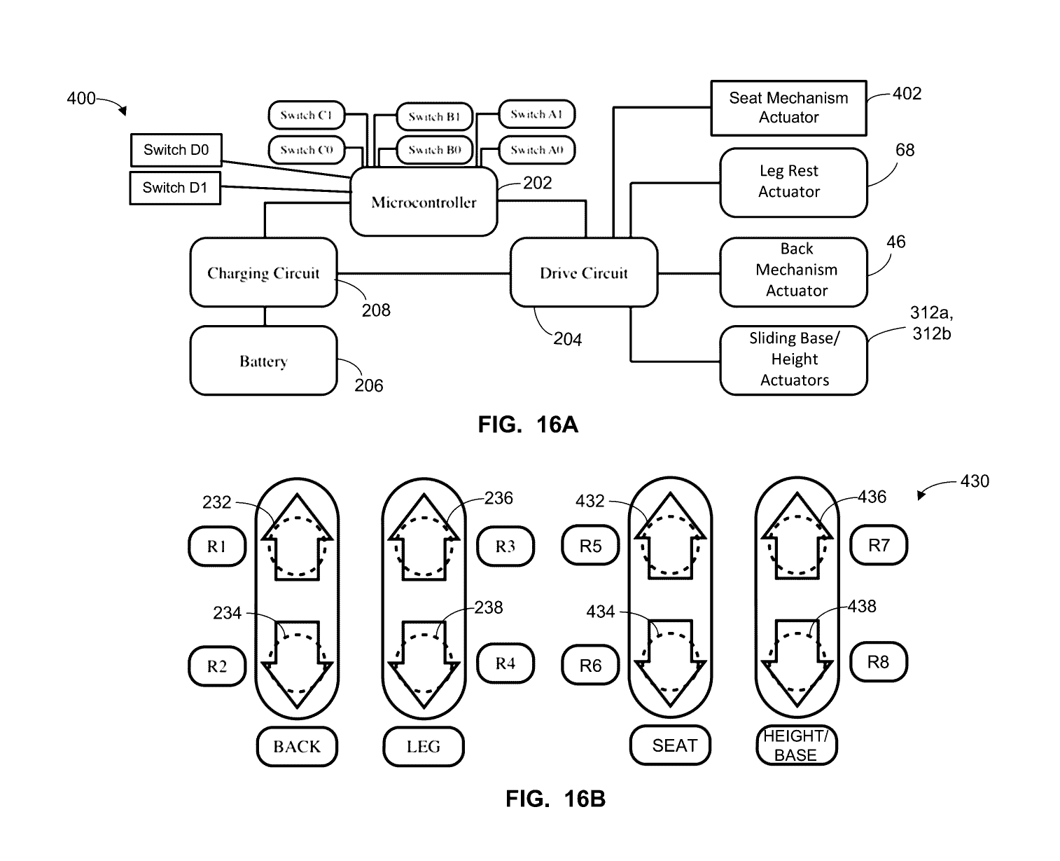

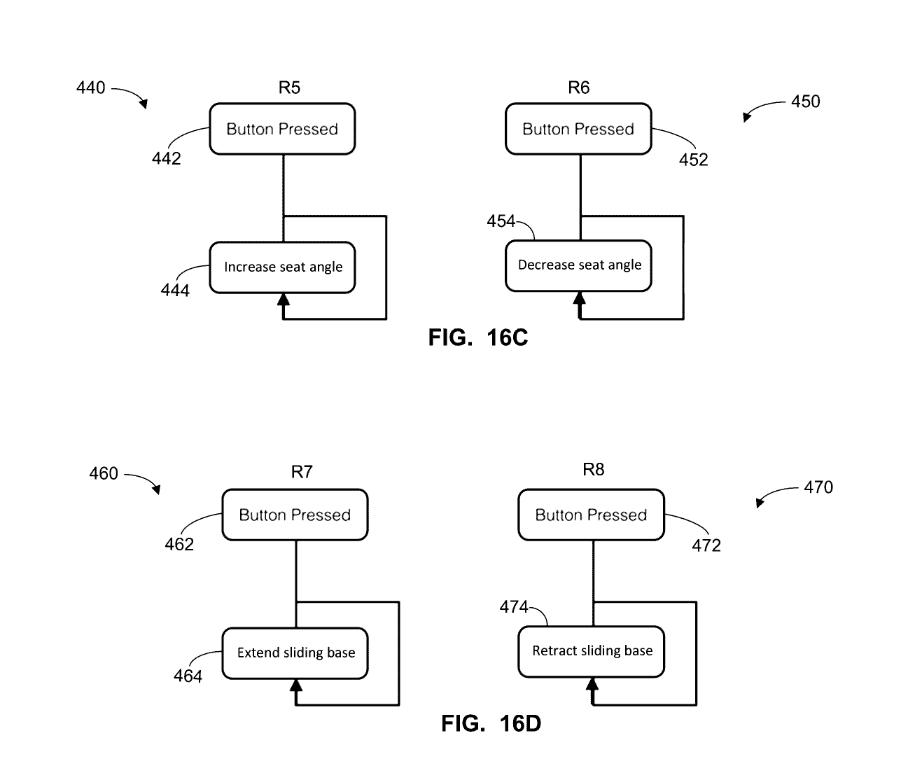

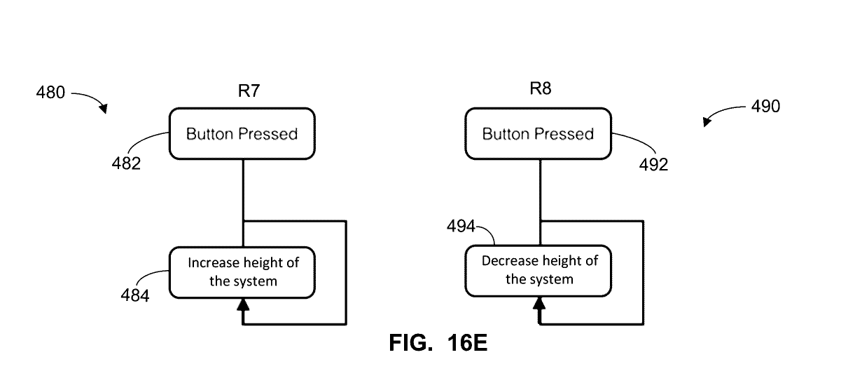

FIG. 8C is an exploded perspective view of an example embodiment of a base assembly that is used for the wheelchair and bed system.

FIG. 8D is an isometric view, a top view, a side view, a rear view and another side view of the base assembly of FIG. 8D.

FIG. 8E is an exploded view of an example embodiment of a leg assembly that is used with the wheelchair and bed system.

FIG. 8F is an isometric view, a top view, a front view and a side view of the seat assembly of FIG. 8F.

FIG. 9A is a block diagram for an example embodiment of the electronics subsystem that is used with the wheelchair and bed system.

FIGS. 9B and 9C are schematic diagrams showing an example of an arrangement of the switches in relation to an actuator of the system.

FIG. 9D shows an example of a user interface that is used with the wheelchair and bed system.

FIGS. 9E and 9F show flowcharts of example methods that is used to control the actuators of the wheelchair and bed system.

FIGS. 10A-10B show front and rear isometric views, respectively, of an example embodiment of a wheelchair and bed system in an upright chair position.

FIGS. 11A and 11B show side views of the wheelchair and bed system of FIGS. 10A-10B in an upright chair position.

FIGS. 12A and 12B show front and rear isometric views of a portion of an example embodiment of a portion of a sliding base assembly used by the wheelchair and bed system of FIGS. 10A-10B.

FIGS. 12C and 12D show a top view and an isometric bottom view, respectively, of a portion of the sliding base assembly.

FIG. 12E shows a cross-sectional top view of both portions of the sliding base assembly.

FIG. 12F shows a cross-sectional view towards the rear of a portion of the sliding base assembly and the height adjustment actuators.

FIG. 12G shows an isometric side view of the wheelchair and bed system of FIGS. 10A-10B, with the sliding base assembly in an extended position.

FIG. 13A shows a cross-sectional side view of the wheelchair and bed system of FIGS. 10A-10B in an upright chair position.

FIG. 13B shows a rear isometric view of a portion of the wheelchair and bed system of FIGS. 10A-10B in an upright position with the height adjustment assembly fully extended and one wheel removed.

FIG. 14A shows a front-top isometric view of the wheelchair and bed system of FIGS. 10A-10B in a reclined position, with the height adjustment assembly fully extended and one wheel removed.

FIG. 14B shows a front-bottom isometric view of the wheelchair and bed system of FIGS. 10A-10B in a reclined position, with the height adjustment assembly fully extended.

FIG. 15A shows a side view of the wheelchair and bed system of FIGS. 10A-10B in a chair position, with a sliding base in a fully retracted position.

FIG. 15B shows a cross-sectional side view of the wheelchair and bed system of FIGS. 10A-10B transitioning from chair position to bed position, with a sliding base in a fully expanded position.

FIG. 15C shows a cross-sectional side view of the wheelchair and bed system of FIGS. 10A-10B in a mid-point reclined position, with the sliding base assembly in a fully retracted position.

FIG. 15D shows a cross-sectional side view of the wheelchair and bed system of FIGS. 10A-10B in a fully reclined position, with the sliding base assembly in a fully extended position.

FIG. 15E shows a cross-sectional side view of the wheelchair and bed system of FIGS. 10A-10B in a reclined position, with the sliding base assembly and height adjustment assembly both fully extended.

FIG. 16A is a block diagram for an example embodiment of the electronics subsystem that is used with the wheelchair and bed system of FIGS. 10A-10B.

FIG. 16B shows an example of a user interface that is used with the wheelchair and bed system of FIGS. 10A to 10B.

FIGS. 16C, 16D and 16E show flowcharts of example methods that are used to control the actuators of the wheelchair and bed system of FIGS. 10A-10B.

Further aspects and features of the example embodiments described herein will appear from the following description taken together with the accompanying drawings.

### DETAILED DESCRIPTION OF THE EMBODIMENTS

Various systems, devices or methods will be described below to provide an example of at least one embodiment of the claimed subject matter. No embodiment described herein limits any claimed subject matter and any claimed subject matter may cover systems, devices or methods that differ from those described herein. The claimed subject matter is not limited to systems, devices or methods having all of the features of any one process or device described below or to features common to multiple or all of the systems, devices or methods described herein. It is possible that a system, device or method described herein is not an embodiment of any claimed subject matter. Any subject matter that is disclosed in a system, device or method described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two or more elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to or receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 10%, for example.

The example embodiments of the systems, devices or methods described in accordance with the teachings herein are generally implemented as a combination of mechanical elements, hardware and software. For example, the embodiments described herein may be implemented, at least in part, by using one or more computer programs, executing on one or more programmable devices comprising at least one processing element, and at least one data storage element (including volatile and non-volatile memory and/or storage elements). These devices may also have at least one input device (e.g. a keyboard, a mouse, a touchscreen, a touchpad, buttons, switches and the like), and at least one output device (e.g. a display screen, a wireless radio, and the like) depending on the nature of the device.

It should also be noted that there may be some elements that are used to implement at least part of the embodiments described herein that may be implemented via software that is written in a high-level procedural language such as object oriented programming. The program code may be written in C, C⁺⁺ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs are stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein are capable of being distributed in a computer program product comprising a computer readable medium that bears computer usable instructions, such as program code, for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

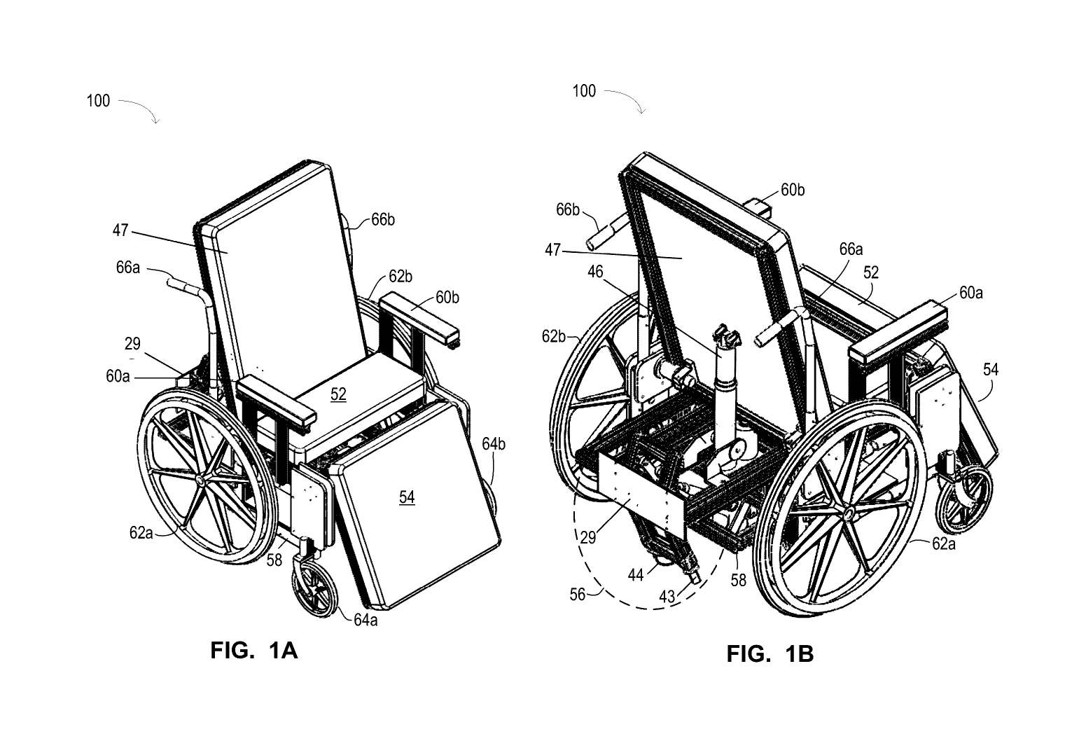

In accordance with the teachings herein, at least one embodiment is provided for a wheelchair and bed system that comprises a sliding base with an automated stabilizing mechanism that is used to automatically transform the wheelchair and bed system between the wheelchair and bed positions. For example, the bed or reclined position for the wheelchair and bed system is generally shown in FIGS. 4, 5A, 5B, and 6 while the upright position for the wheelchair and bed system is generally shown in FIGS. 1A, 18, 2A, 2B, 3, 6, 7A, 7G, and 7H for one example embodiment. In another example embodiment, the bed or reclined position for the wheelchair and bed system is generally shown in FIGS. 12G, 14A, 14B, and 15C-15E while the upright position for the wheelchair and bed system is generally shown in FIGS. 10A-10B, 11A, 118, 13A, 13B and 15A.

The automated stabilizing mechanism allows the wheelchair and bed system to function as a standalone system without requiring any external peripherals when in either bed or wheelchair position. The automated stabilizing mechanism also provides complete stability while the wheelchair and bed system is in bed form. Accordingly, the transformation is done safely and efficiently to reduce the risk of injury for both a care provider and a person with reduced mobility when moving the person from a sitting-upright position when the wheelchair and bed system is in wheelchair mode to a sedentary position on a bed when the wheelchair and bed system is in bed mode.

Referring now to FIGS. 1A and 1B, shown therein are front and rear isometric views, respectively, of an example embodiment of a wheelchair and bed system 100 in an upright wheelchair position. The system 100 generally comprises a back mechanism assembly 47, a seat assembly 52, a leg mechanism assembly 54, and a sliding base mechanism 56 that are all coupled to a chassis 58. The back mechanism assembly 47, the leg mechanism assembly 54 and the sliding base mechanism 56 are movably coupled to the chassis 58 as these elements move when the system 100 transitions between a wheelchair position in a wheelchair mode and a bed position in bed mode. In the wheelchair mode, the back mechanism assembly 47 is in a vertical upright position, the seat assembly is in a horizontal position and the leg mechanism assembly 54 is slightly angled.

The system 100 further comprises right and left arm rests 60a and 60b, right and left rear wheels 62a and 62b, right and left front wheels 64a and 64b and right and left handles 66a and 66b that are mounted to the chassis 58. The right and left arm rests 60a and 60b and the right and left handles 66a and 66b are rigidly mounted to the chassis 58 while the right and left rear wheels 62a and 62b and the right and left front wheels 64a and 64b are rotatably mounted to the chassis 58. Elements 60a, 60b, 62a, 62b, 64a, 64b, 66a and 66b are used to transport an individual in a seated position when the system 100 is in wheelchair mode.

The system 100 also includes rear right and left caster wheels 43 and 44 that are not used when the system 100 is in wheelchair mode but are lowered to the ground when the system 100 is in bed mode to provide additional stability. The caster wheels 43 and 44 are pivotably mounted to the chassis 58 so that they can rotate as the system 100 transitions between the wheelchair and bed positions.

The system 100 also includes a mounting plate 29 to which other components of the sliding base mechanism 56 are mounted. The orientation of the mounting plate 29 is substantially vertical and relatively constant when the system 100 transitions between the wheelchair and bed positions.

The system 100 also includes a back mechanism actuator 46 which is used to rotate the back mechanism assembly 47 to different positions as the wheelchair transitions between the wheelchair and bed positions. For example, in the wheelchair position, the back mechanism actuator 46 is actuated to maintain the back mechanism assembly 47 in an upright position. As the system 100 then transitions from the wheelchair position to the bed position, the back mechanism actuator 46 is actuated to contract thereby pulling the back mechanism assembly 47 along a downwards arc as the back mechanism assembly 47 moves to a horizontal position. In contrast, as the system 100 transitions from the bed position to the wheelchair position, the back mechanism actuator 46 extends to the push the back mechanism assembly 47 along an upwards arc as the back mechanism assembly 47 moves to a vertical upright position.

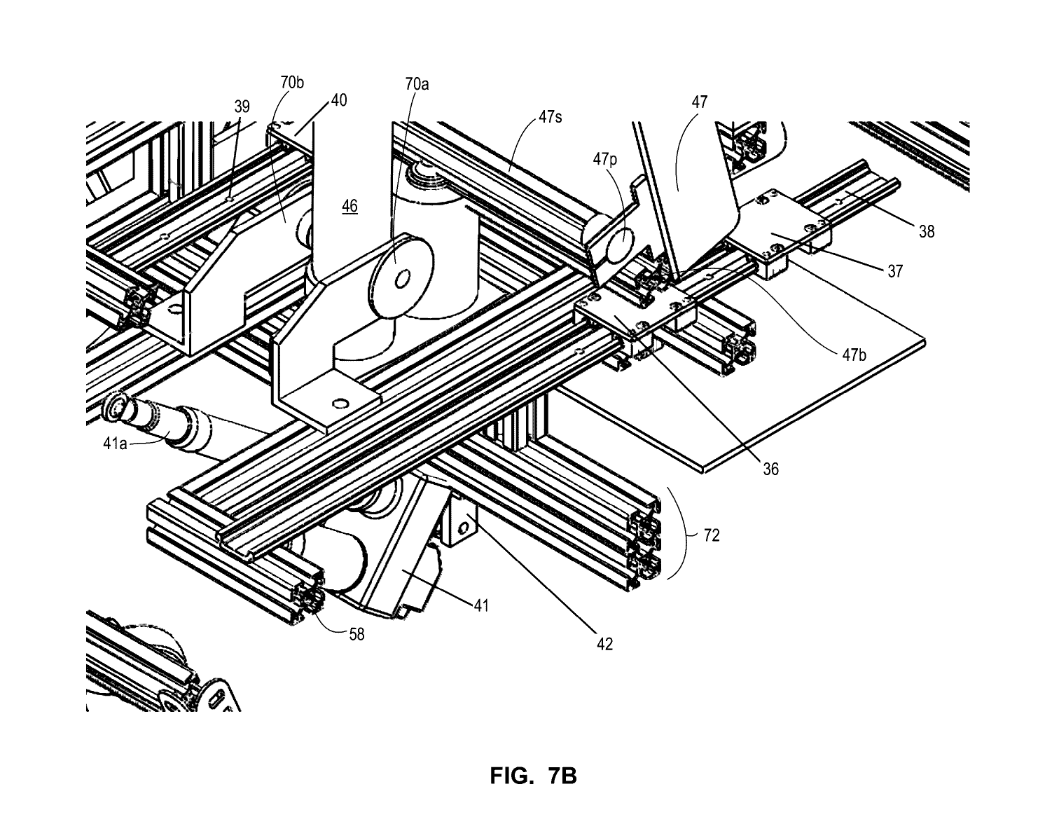

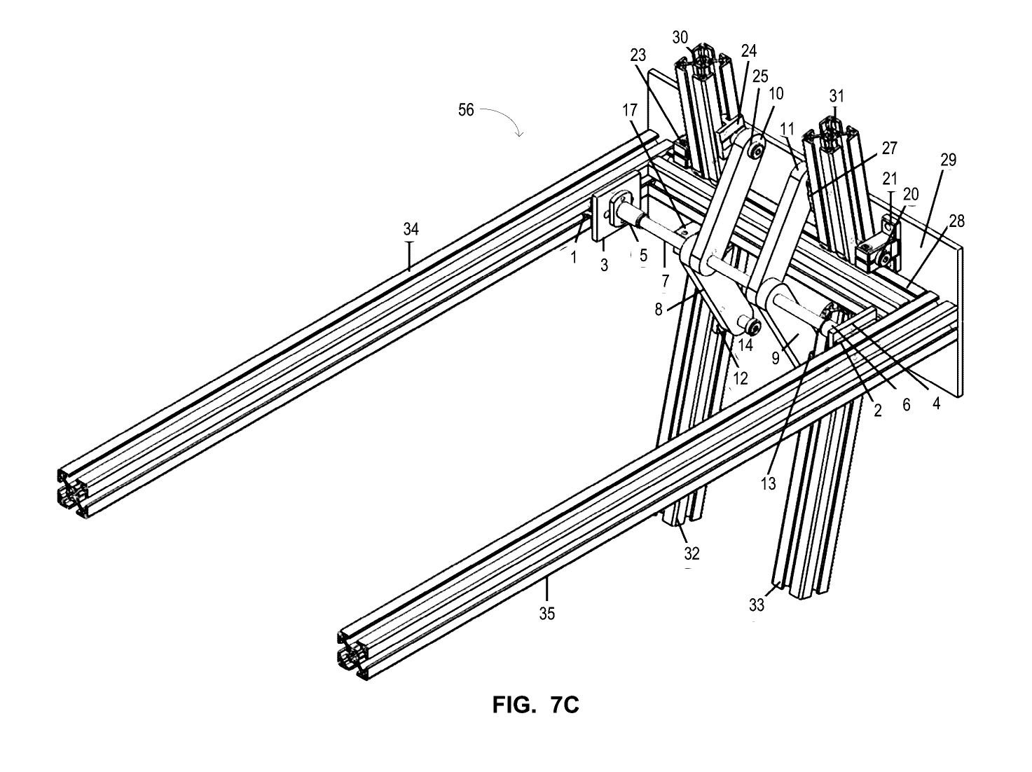

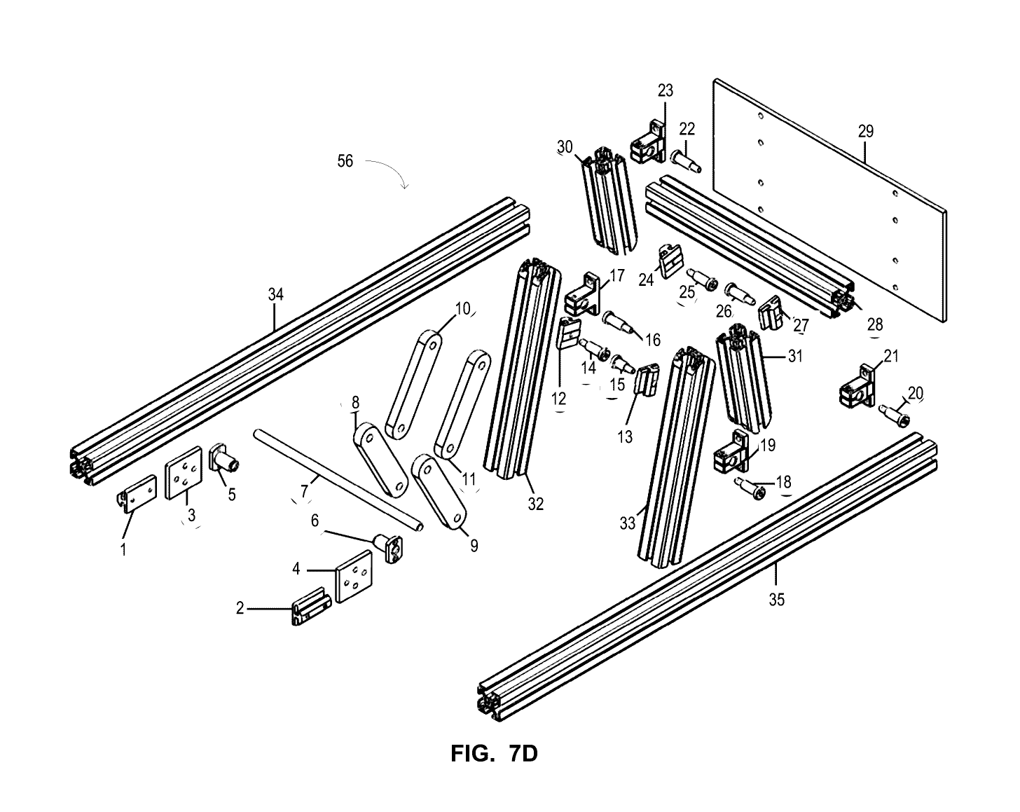

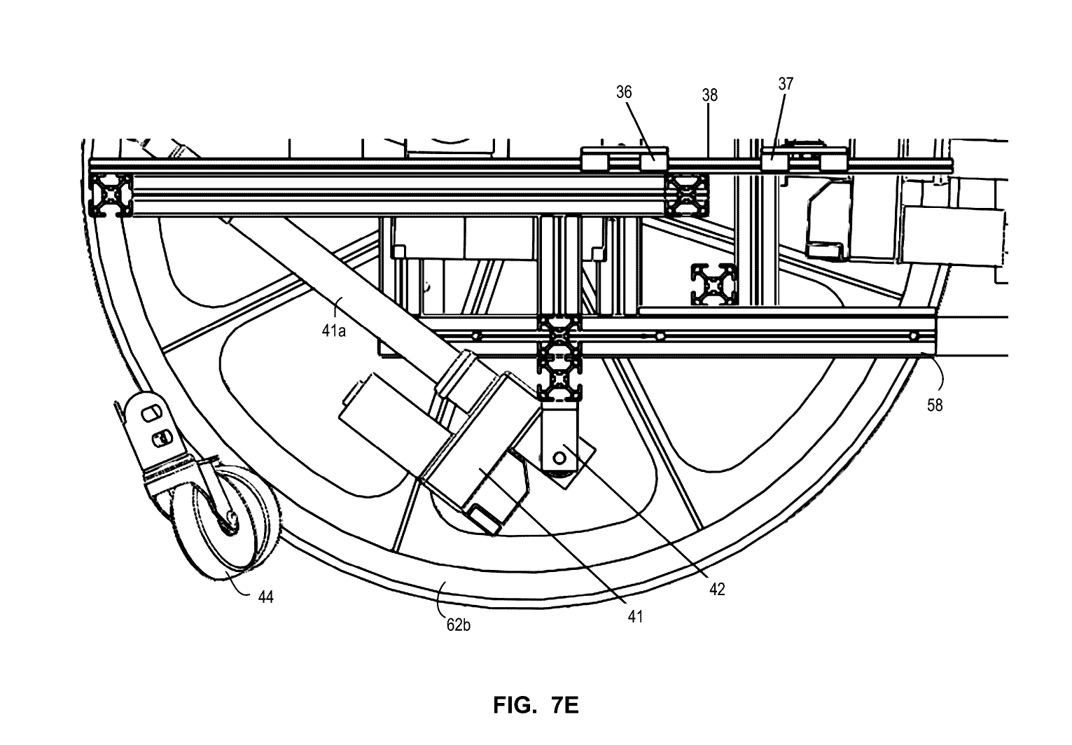

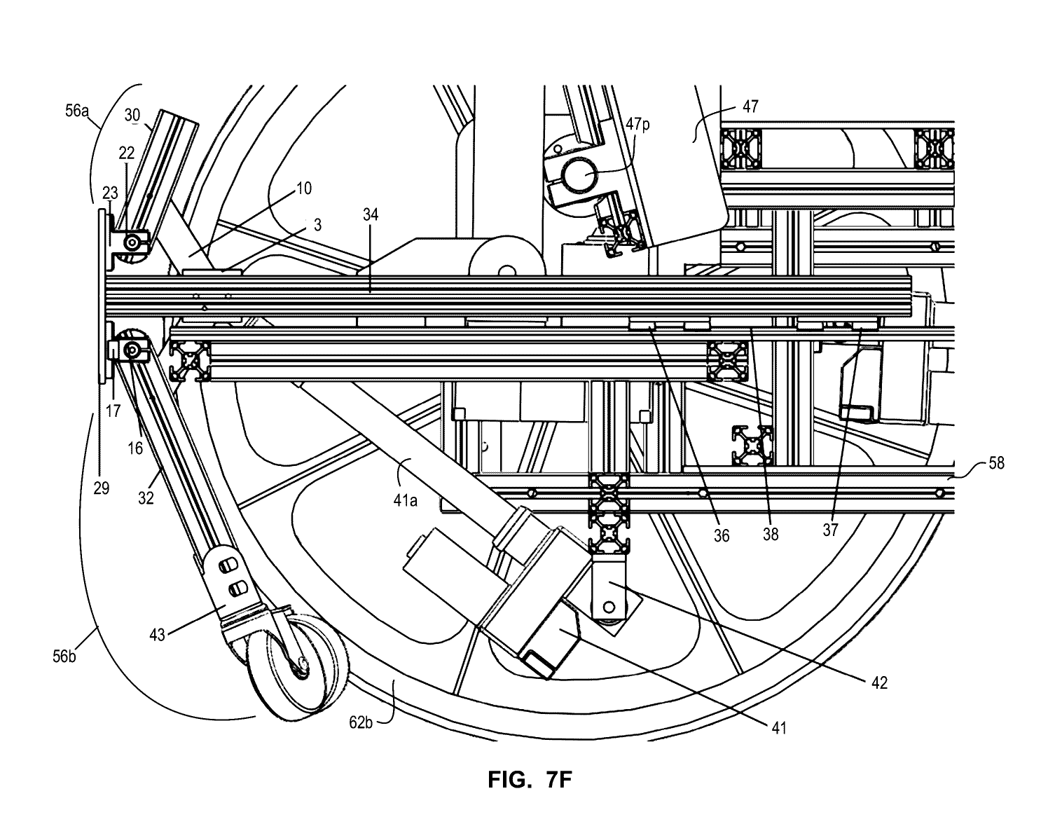

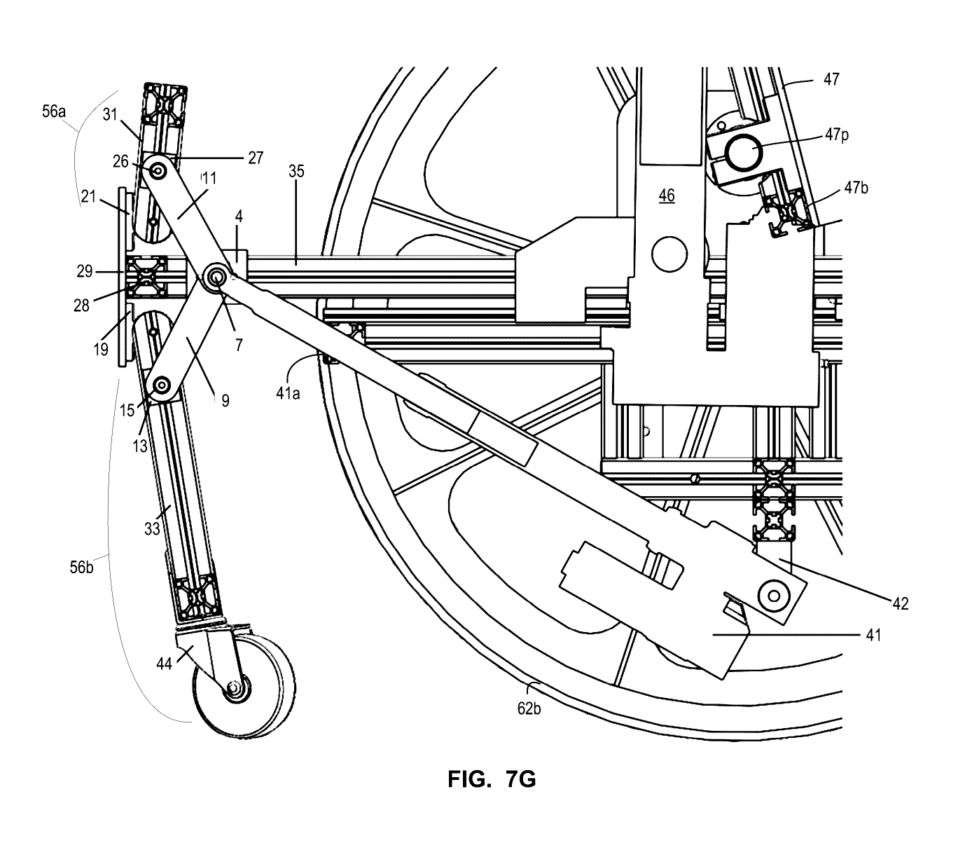

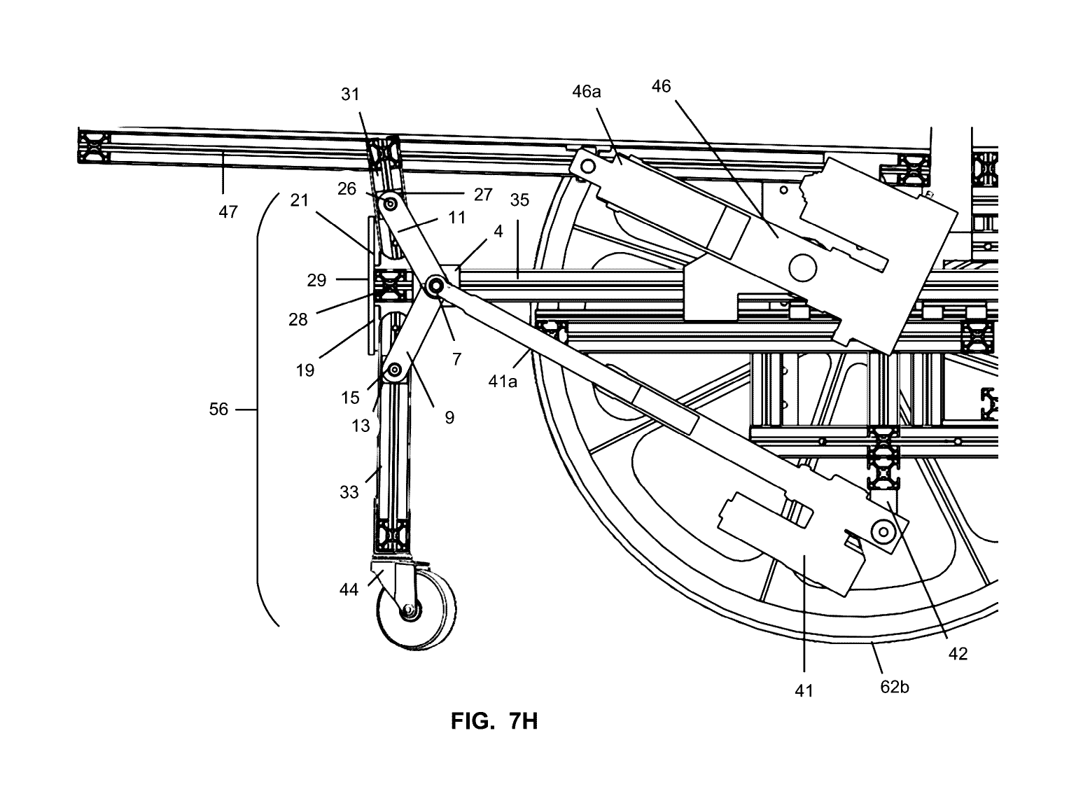

The back mechanism actuator 46 may be a 4 inch actuator that is rotatably coupled at two ends to the back plate 101 with both of these ends acting as pivots. The arm 46a or shaft of the back mechanism actuator 46 is coupled via shaft supports to the back plate 101, while the other end of the back mechanism actuator 43 is mounted on both sides to brackets 70a and 70b that are in turn mounted to the chassis 58. The brackets 70a and 70b are mounted to the back mechanism actuator 46 so as to allow the back mechanism actuator 46 to pivot during transformations (see FIGS. 7A, 7B and 8B).

The leg mechanism assembly 54 is designed to follow a very similar construction and assembly method as to the back mechanism assembly where a single leg mechanism actuator 68, which may be a 4 inch actuator, is used to perform transformations to the leg mechanism assembly 54 to rotate the leg mechanism assembly 54 between the wheelchair position and the bed position. One challenge with the design of the leg mechanism assembly 54 was ensuring that the leg mechanism actuator 68 was capable of extending upwards to hold the leg mechanism 54 fully flat (e.g. requiring it to be as close as possible to the pivot), while also ensuring that leg mechanism actuator 68 was disposed far enough within the chassis 58 of the system 100 in to provide a comfortable sitting angle when an individual was sitting in the system 100 and using it in wheelchair position. Using different safety factors, a MATLAB analysis was conducted to determine a list of acceptable solutions that will allow the leg mechanism actuator 68 to behave as described herein.

When transforming from the wheelchair position to the bed position, the sliding base mechanism 56 generally slides out first and then the back mechanism assembly 47 rotates downwards to rest upon the upper portion of the sliding base mechanism 56. When transforming from the bed position to the wheelchair position, the back mechanism assembly 47 first rotates upwards, and then the sliding base mechanism 56 slides in (i.e. retracts) between the rear wheels 62a and 62b.

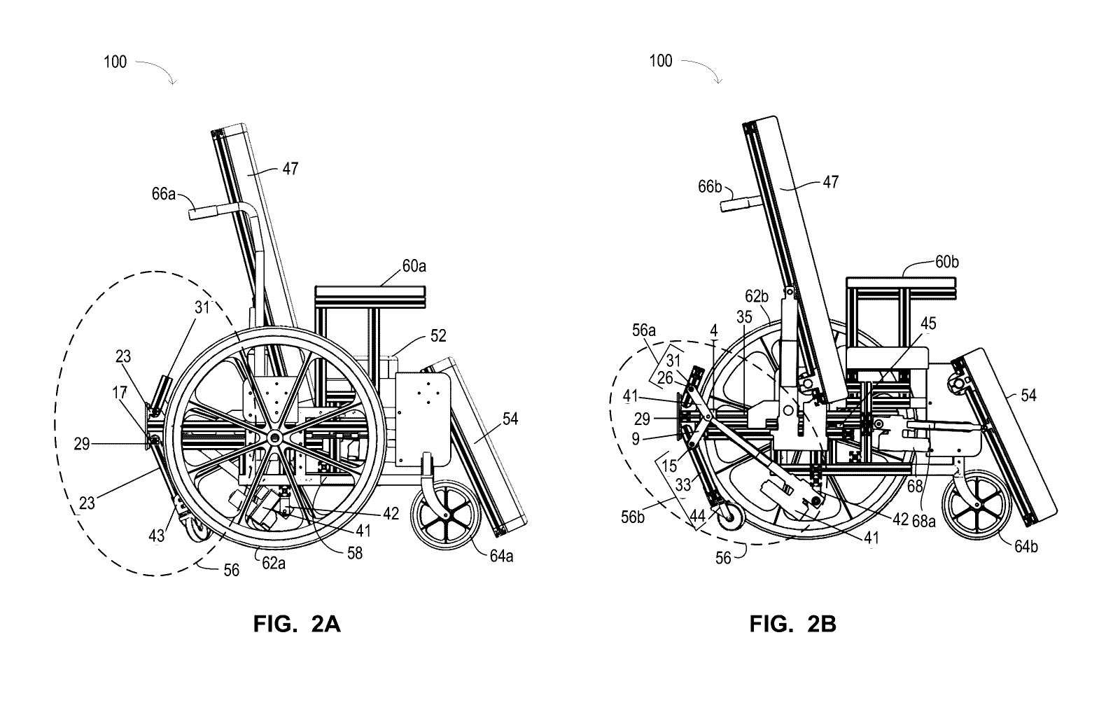

Referring now to FIGS. 2A and 2B, shown therein is a side view and a cross-sectional side view, respectively, of the system 100 in the upright wheelchair position. It can be seen that the sliding base mechanism 56 comprises several elements many of which move when the system 100 transitions between the wheelchair and bed positions.

The sliding base mechanism 56 comprises a sliding base actuator 41 that is mounted via shaft supports 42 to the chassis 58. The sliding base actuator 41 is used to slide in and out the sliding base mechanism 56 when transitioning between the wheelchair position and the bed position. Accordingly, the sliding base actuator 41 has an arm 41a that is coupled a linear shaft 7 to which upper and lower portions 56a and 56b of the sliding base mechanism 56 are rotatably coupled via linkages 8, 9, 10 and 11 (see FIG. 7C). The upper and lower portions 56a and 56b of the sliding base mechanism 56 rotate to a vertical position when the system 100 transitions to the bed position in order to provide additional structural stability. Accordingly, the sliding base mechanism 56 is fully extended in the bed position and actuates the upper and lower portions 56a and 56b of the sliding base mechanism via a scissor mechanism.

The upper portion 56a of the sliding base mechanism 56 comprises two upper posts 30 and 31 that pivot about a horizontal support member 28 that is mounted to the mounting plate 29. The upper posts 30 and 31 are rotatably coupled to upper links 10 and 11, respectively, via upper sliders 24 and 27 that have bosses (a.k.a. ribs) that slidably engage grooves (a.k.a. channels) in the upper posts 30 and 31 and are then fixed in position. The sliders may be Delrin sliders for aluminum extrusions (counterbored small).

The lower portion 56b of the sliding base mechanism 56 comprises two lower posts 32 and 33 that are coupled to caster wheels 43 and 44. The two lower posts 32 and 33 are rotatably coupled to lower links 8 and 9, respectively, via lower sliders 12 and 13 that have bosses (a.k.a. ribs) that slidably engage grooves (a.k.a. channels) in the lower posts 32 and 33 and are then fixed in position.

In the wheelchair position, the upper portion 56a of the sliding base mechanism 56 is at an angled position where it does not engage any part of the back mechanism assembly 47. Likewise, the lower portion 56b of the sliding base mechanism is at an angled position so that the caster wheels 43 and 44 do not make contact with the ground. When the system 100 transitions to the bed position from the wheelchair position, the arm 41a of the sliding base actuator 41 extends away from the chassis 58 and the sliding base actuator 41 also rotates in an anti-clockwise manner with respect to a pivot point at the base of the shaft support 42 which pushes the linear shaft 7 in a rearward direction away from the back mechanism assembly 47. Looking outwards from inside the system, this action causes horizontal movement to the left of bushing mount 4 and to the right of bushing mount 3. This action also causes the upper linkages 10 and 11 to rotate towards the back mechanism assembly 47 which exerts an upward force on the upper sliders 24 and 27 which in turn causes the upper posts 30 and 31 to rotate away from the back mechanism assembly 47 and move to a vertical position. In the vertical position, ends of the upper posts 30 and 31 contact rear portions of the back mechanism assembly 47 and act as support surfaces for the back mechanism assembly 47. At the same time, as the arm 41a of the sliding base actuator 41 extends away from the chassis 58 and the linear shaft 7 is pushed in a rearward direction away from the back mechanism assembly 47, the lower linkages 10 and 11 rotate towards the back mechanism assembly 47 which exerts a downward force on the lower sliders 12 and 13 which in turn causes the lower posts 32 and 33 to rotate away from the back mechanism assembly 47 and move to a vertical position. In the vertical position, the caster wheels 43 and 44 that are coupled to the lower posts 32 and 33, respectively, make contact with the floor underneath the system 100. In the wheelchair position, the upper posts 30 and 31 and the lower posts 32 and 33 make contact with the horizontal support member 28. The horizontal support member 28 rests on the lower posts 32 and 33 and is coupled to the ground through the lower posts 32 and 33. The back mechanism assembly 47 rests on the upper posts 30 and 31 which in turn are supported by the horizontal support member 28 thereby providing and maintaining stability when the system is in the bed mode.

In an alternative embodiment, the linear translation mechanism provided by the sliding base actuator 41 are replaced by with motors that have spur gears attached to the end of the motor shaft (facing outwards), which would be mated with a linear gear. This system can be mounted on either end of a support member. In the middle of this support member is a shortened precision linear shaft where the linkages 8, 9, 10 and 11 are allowed to be mounted in a similar way as seen in FIG. 2. This rack and pinion mechanism also causes a lateral translation of the shaft 7, during the transition of the wheelchair and bed system 100 between the wheelchair and bed positions.

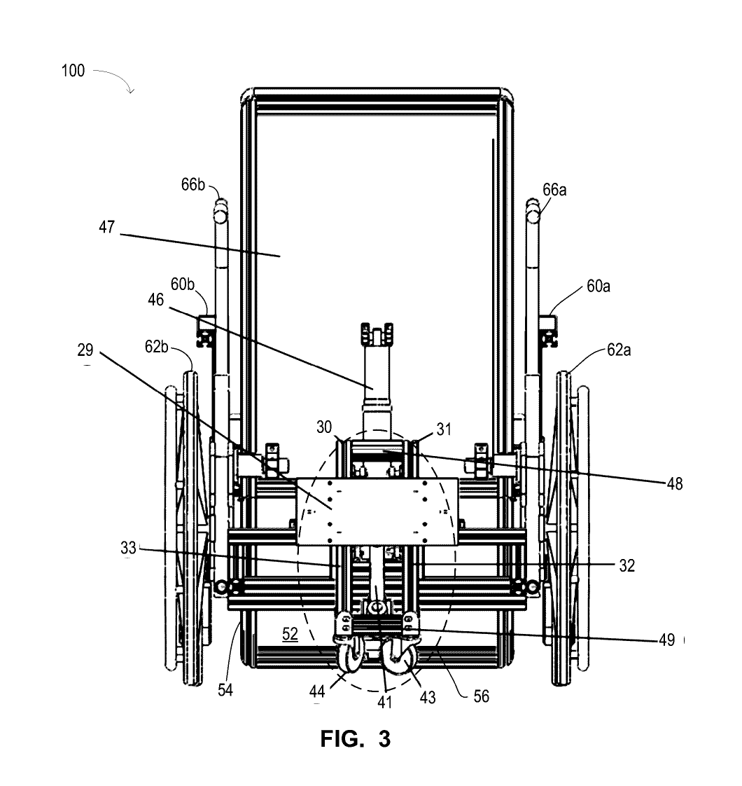

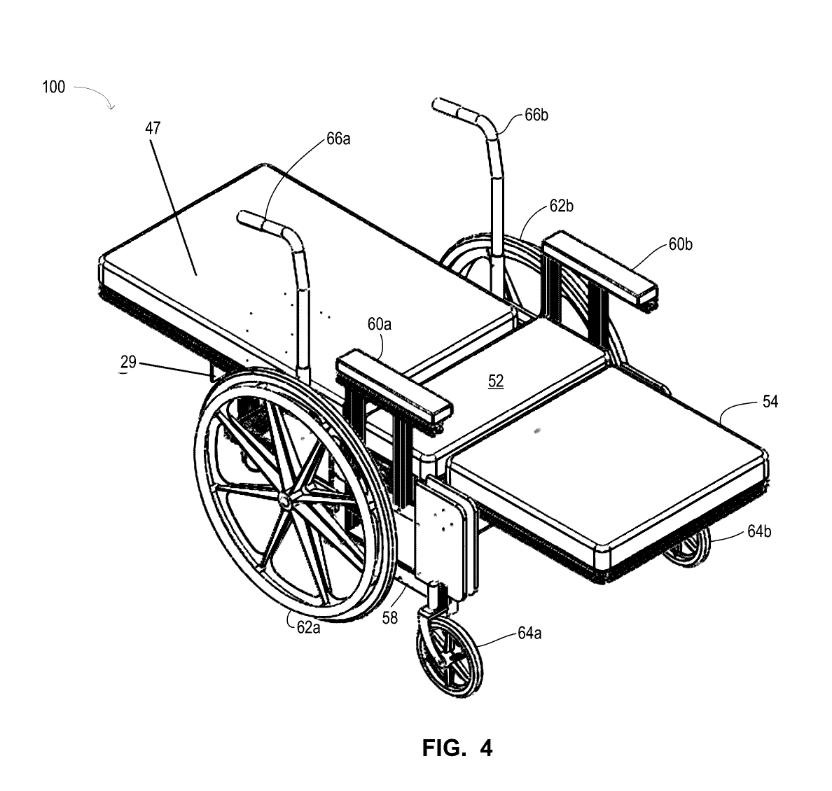

Referring now to FIG. 3, shown therein is a rear view of the system 100 in the upright chair position. In this example embodiment, the back mechanism actuator 46 and the sliding base actuator 41 is aligned such that they have the same longitudinal axis along the middle of the wheelchair and bed system 100. This allows for efficient work to be done by the actuators on the various components since the actuation forces act on the middle of the back and leg plates versus acting closer to one side of these components. The arm of the back mechanism actuator 46 extends and pivotally couples to a height of about one-third of the back mechanism assembly 47. Furthermore, the sliding base mechanism 56 is centered at a midpoint of the system 100. In addition, for improved stability, the upper post 30 is collinear with the lower post 32 and the caster wheel 44, while the upper post 31 is collinear with the lower post 33 and the caster wheel 43.

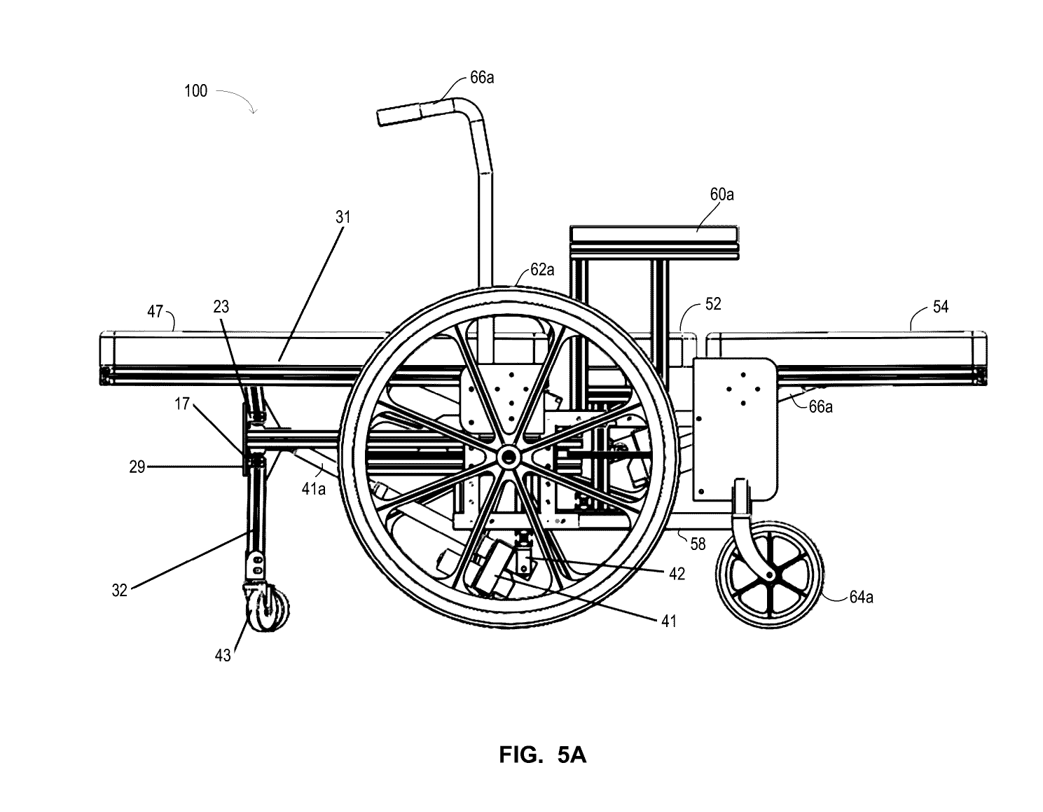

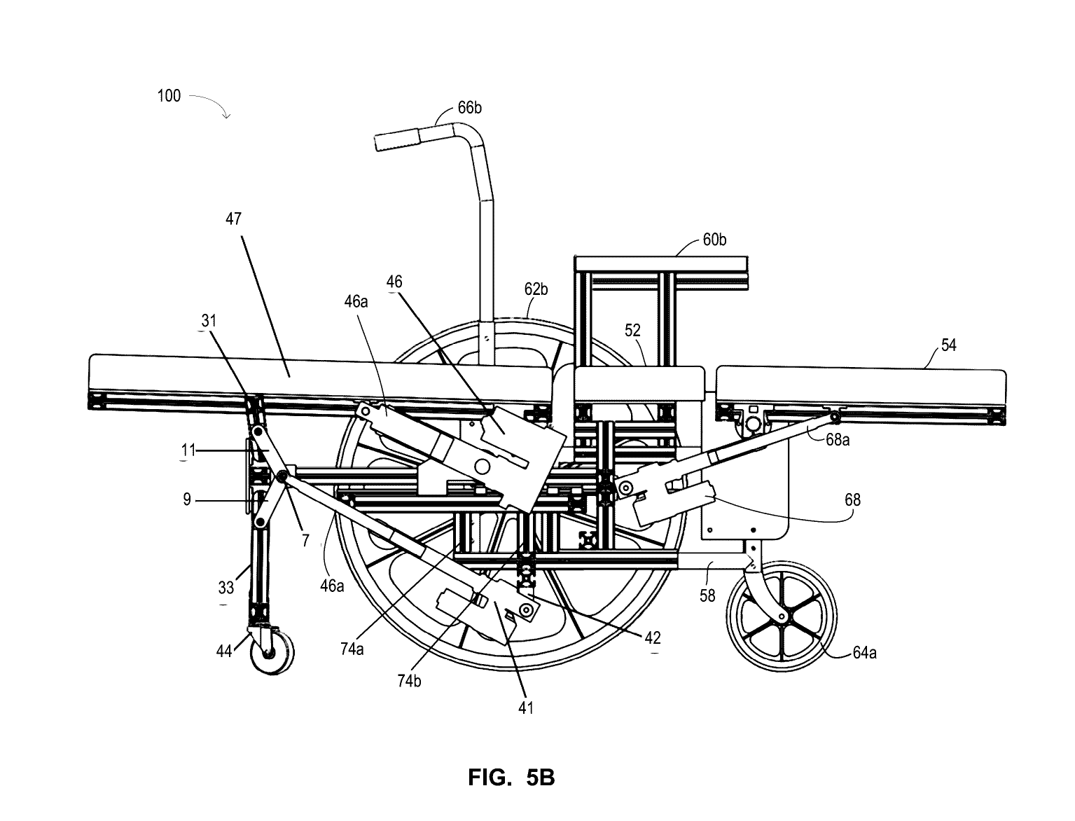

Referring now to FIG. 4, shown therein is a front isometric view of the wheelchair and bed system 100 in a reclined bed position. In this position, the back mechanism assembly 47 has been lowered and the leg extension assembly has been raised so that they are substantially coplanar with the seat assembly 52. Comparison of FIGS. 2B and 5B shows how the orientation and extension of the leg mechanism actuator 68 changes. The extension of the leg mechanism actuator 68, coupled with the pivot points (where the leg mechanism actuator 68 is mounted and applies force) and bushings mounted on the leg mechanism plate 180 causes the leg mechanism assembly 54 to rotate in an anti-clockwise direction. Note that this is an independent action to the rotating back mechanism assembly 47 and the automated stabilizing system provided by the sliding base mechanism 56.

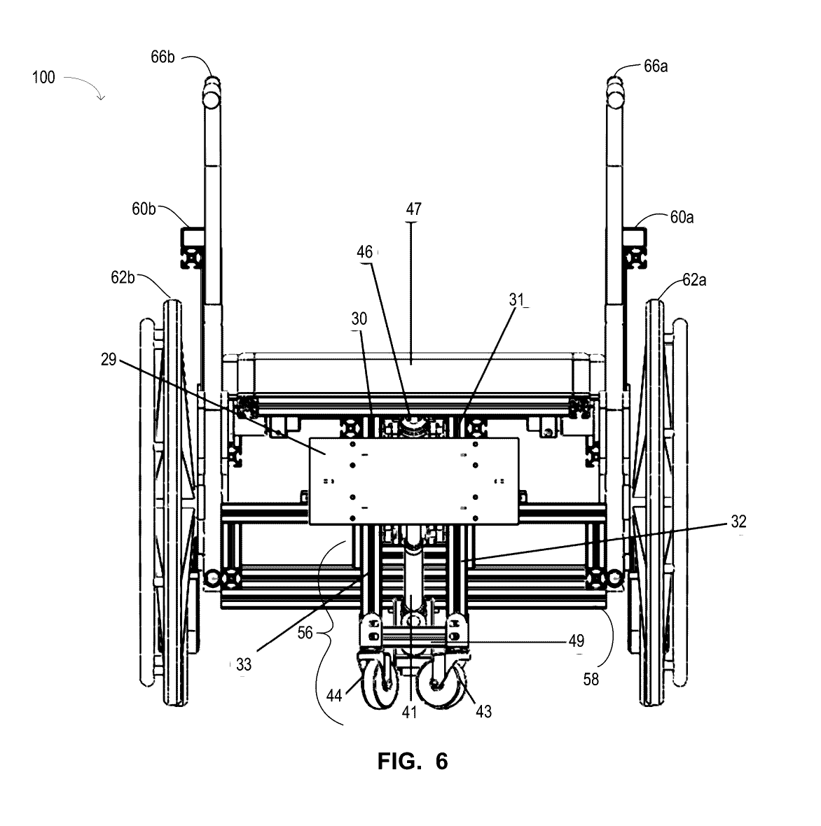

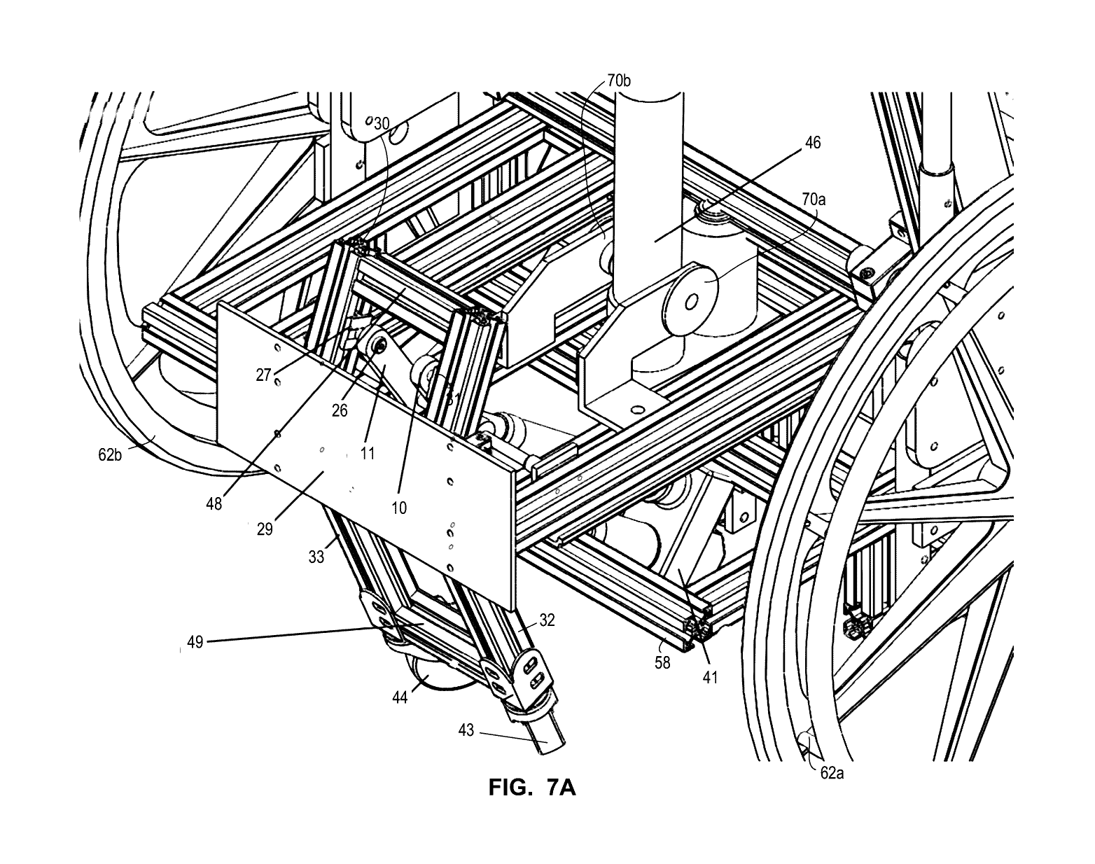

Referring now to FIGS. 5A, 5B and 6, shown therein is a side view, a cross-sectional side view and a rear view, respectively, of the wheelchair and bed system 100 in the reclined bed position. The system 100 comprises a leg assembly actuator 68 with an arm 68a for raising the leg assembly when the system 100 transitions to the bed position. The system 100 also includes a first pair of lower and upper shaft supports 17 and 23 and a second pair of lower and upper shaft supports 19 and 21 that are mounted on the mounting plate 29 adjacent to the horizontal support member 28 to allow for a more stable structure for the sliding base mechanism 56. The first pair of shaft supports 17 and 23 are disposed near a first end portion of the horizontal support member 28 and the second pair of shaft supports 19 and 21 are disposed on a second end portion of the horizontal support member 28. The first pair of shaft supports 17 and 23 are coupled to the lower and upper posts 32 and 30, respectively, using fasteners 16 and 22 such as fulcrum pins that engage sockets in the shaft supports 17 and 23. The shaft supports 17 and 23 are coupled to the mounting plate 29 via fasteners, such as screws or pins, for example. The second pair of shaft supports 19 and 21 are coupled to the lower and upper posts 33 and 31, respectively, using fasteners 18 and 20 such as fulcrum pins that engage sockets in the shaft supports 19 and 21. The shaft supports are 19 and 21 coupled to the mounting plate 29 via fasteners, such as screws or pins, for example.

Referring now to FIG. 7A, shown therein is an isometric view of an example embodiment of the wheelchair and bed system 100 and the mounted automated stabilizing mechanism 56. For increased stability when the system 100 is in the bed position, a first horizontal member 49 is used to couple lower end portions of the lower posts 32 and 33 together. In addition, in at least some embodiments, for increased stability when the system 100 is in the bed position, a second horizontal member 48 is used to couple upper end portions of the upper posts 30 and 31 together. In addition, brackets 70a and 70b are used to couple the back assembly actuator 46 to the chassis 58. The brackets 70a and 70b also act as pivot points for the back mechanism actuator 46. As the back mechanism actuator 46 extends, it rotates up and away from the sliding base mechanism into an upright position when the system 100 transitions from the bed position to the wheelchair position.

Referring now to FIG. 7B, shown therein is an isometric view of an example embodiment of first and second pairs of mounting carriages 36, 37, 40 and 45 that are used to move a sliding base assembly 56. The first pair of mounting carriages 36 and 37 slidably engages a first rail 38 on one side of the sliding base assembly 56. The second pair of mounting carriages 40 and slidably engages a second rail 39 on a second side of the sliding base assembly 56. The first and second rails 38 and 39 are linear rails that are fixedly mounted on the chassis 58. The base 47b of the back mechanism assembly 47 is also pivotally coupled to a shaft 47s at a pivot point 47p.

Also, depending on the material that is used for chassis 58, more support members may be added to the chassis 58 to provide more support for mounting the back mechanism actuator 46. For example, two support members 74a and 74b (see FIG. 5B) may be added between the plate supporting the back mechanism and the mounting extrude for the sliding base mechanism to support the back mechanism assembly 47 and improve structural stability. The support members 72 may be used to lower the pivot point of the sliding base actuator 41 to increase reliability and smoothness of operation.

During use when the system 100 transitions to the wheelchair position, the arm 46a of the back mechanism actuator 46 is extended to move the back mechanism assembly 47 to the upright position, the base 47b of the back mechanism assembly 47 rotates forward and the mounting carriages 36, 37, 40 and 45 slide along rails 38 and 39, respectively, towards the front of the system 100. Accordingly, the sliding base assembly 56 tucks into the overall system in wheelchair mode. Alternatively, during use when the system 100 transitions to the bed position, the sliding base assembly 56 is extended outwards to the back of the system 100 and the arm 46a of the back mechanism actuator 46 is retracted to move the back mechanism assembly 47 to the horizontal position, the base 47b of the back mechanism assembly 47 rotates backwards and the mounting carriages 36, 37, 40 and 45 slide along rails 38 and 39, respectively, away from the front of the system 100. Accordingly, the sliding base assembly 56 is extended in bed mode. The sliding base assembly 56 and the carriages 36, 37, 40 and 45 move at the same time.

In an alternative embodiment, instead of using the rails 38, 39 and the mounting carriages 36, 37, 40 and 45 as the linear translation mechanism, a different linear translation mechanism is used such as spur gears and pinions, which would be mated with a linear gear/rack (that faces outwards). These spur gears and pinions and linear gear/rack are placed on both sides. This would allow various components shown in FIG. 7B to slide in the desired directions.

Referring now to FIGS. 7C and 7D, shown therein is an isometric view and an isometric exploded view of the automated stabilizing mechanism 56 for the wheelchair and bed system 100. One end of the linear shaft 7 is coupled to a first slider 1 via a first attachment comprising a first bushing mount 3 and a first bushing 5 and a second end of the linear shaft 7 is coupled to a second slider 2 via a second attachment comprising a second bushing mount 4 and a second busing 6. The sliders 1 and 2 have bosses that engage channels within rails 34 and 35, respectively. The rails 34 and 35 are fixedly mounted to the chassis 58. In use, when the arm 41a of the actuator 41 extends to transition the system 100 to the bed position or retracts to transition the system 100 to the wheelchair position, the arm 41a pushes or pulls on the linear shaft 7 which causes the ends of the linear shaft 7 to move along the rails 34 and 35 via the first and second sliders 1 and 2.

Still referring to FIGS. 7C and 7D, it can be seen that a first end of the links 8 and 9 have channels or apertures to receive the linear shaft 7 which allows the links 8 and 9 to rotate about the linear shaft 7. The second ends of the links 8 and 9 are rotatably and slidably coupled to sliders 12 and 13 via fasteners 14 and 15 respectively, which are fulcrum pins that engage sockets at the second ends of the links 8 and 9. Likewise, a first end of the links 10 and 11 have channels or apertures to receive the linear shaft 7 which allows the links 10 and 11 to rotate about the linear shaft 7. The second ends of the links 10 and 11 are rotatably and slidably coupled to sliders 24 and 27 via fasteners 25 and 26 respectively, which are fulcrum pins that engage sockets at the second ends of the links 10 and 11.

Referring now to FIGS. 7E to 7H, shown therein are partial cross-sectional side views of the automated stabilizing system as the wheelchair and bed system transitions from the chair position (FIGS. 7E and 7F) to the bed position (FIG. 7H). In this example, FIGS. 7F and 7G show the sliding base mechanism 56 extending outwards from the back of the system 100 from a first position where the sliding base mechanism 56 is adjacent the rear wheels 62a and 62b of the system to a second position where the sliding base mechanism extends behind the rear wheels 62a and 62b as the arm 41a of the sliding base actuator 41 is extended. The amount of extension or contraction of the sliding base actuator 41 is controlled using limit switches that are mounted to indicate when the sliding base actuator 41 has extended far enough for the back mechanism assembly 47 to be stable or when the sliding base actuator 41 has contracted far enough for the sliding base mechanism 56 to be positioned between the rear wheels 62a and 62b. Limit switches may be used for the other actuators in a similar manner.

As the arm 41a continues to extend, the upper portion 56a and the lower portion 56b of the sliding base mechanism 56 rotate backwards to upright positions. These motions continue until the upper and lower portions 56a and 56b of the sliding base mechanism 56 are vertical. At this point, the arm 46a of the back mechanism actuator 46 is retracted and the back mechanism assembly 47 pivots backwards until the back mechanism assembly is in a desired position, such as the horizontal position where the back mechanism assembly 47 rests on the support posts 30 and 31 of the sliding base mechanism 56. It should be noted that in some embodiments, the sliding base mechanism 56 is first fully extended before the back mechanism assembly 47 is lowered, as was described from FIGS. 7E to 7H. Alternatively, in other embodiments, the sliding base mechanism 56 is extended at the same time as the back mechanism assembly 47 is lowered. In these embodiments, the rate of descent of the back mechanism assembly 47 is slower than the rate of extension of the sliding base mechanism 56 so that the sliding base mechanism is in position to support the back mechanism assembly 47 in a stable manner when the back mechanism assembly 47 is fully reclined.

Referring now to FIGS. 8A and 8B, shown therein an exploded view, an isometric view, a front view, a top view, and a side view respectively, of an example embodiment of the back assembly 47 that is used with the wheelchair and bed system 100. The back assembly 47 comprises a back plate 101, frame supports 102, 104, 106 and 108, shafts 110 and 112, and fasteners 114, 116, 118, 120, 122 and 124. In this example embodiment, the fasteners 114 and 116 are shaft supports, the fasteners 118 and 120 are bushings and the fasteners 122 and 124 are shaft supports. The back plate 101 is mounted to the chassis 158 of the wheelchair and bed system 100 by utilizing the fasteners 114, 116, 118, and 120. The shaft support 122 and the shaft 124 are used to couple the back plate 101 to the arm of the back mechanism actuator 46. A back cushion (not shown) or other suitable surface is attached to the front of the back plate 101.

The frame supports 102, 104, 106, and 108 are attached to the back plate 101 and provide structural support. End portions of the frame supports 104 and 108 include C-shaped grooves spaced apart from ends of the supports 104 and 108 to receive the fasteners 114, 116, 118, 120 and shafts 110 and 112 that are used to rotatably couple the back mechanism assembly 47 to mounts on the chassis 58.

The shaft supports 114 and 116 are received within the C-shaped grooves of the supports 104 and 108 and are attached to the back plate 101. The brackets 114 and 116 comprise channels that are sized to receive the shafts 110 and 112 respectively. End portions of the shafts 110 and 112 that extend from the shaft supports 114 and 116, respectively, receive inner portions of the bushings 118 and 120, respectively, such that the non-flanged portions of the bushings 118 and 120 are adjacent to outer edges of the shaft supports 114 and 116 respectively and the flanged portions are adjacent to a portion of the frame of the system 100. The shafts 110 and 112 and the bushings 118 and 120 allow the back mechanism assembly 47 to pivot when the system 100 transitions between the bed and wheelchair positions.

Also, in this example embodiment, the fastener 122 is a pair of shaft supports and the fastener 124 is a pin or a shaft. The pair of shaft supports 122 have prongs with apertures and are mounted to the back plate 101 so that they are spaced apart. The prongs of the shaft support 122 receive an end of the arm of the back mechanism actuator 46 between them. The end of the arm of the back mechanism actuator 46 has a channel and the pin 124 is slid through one prong of the shaft support 122, through the channel of the arm of the back mechanism actuator 46 and then through the other prong of the shaft support 122 to rotatably couple the back mechanism assembly 47 to the arm of the back mechanism actuator 46.

Referring now to FIGS. 8C and 8D, shown therein is an exploded perspective view, an isometric view, a top view, a side view, a rear view, and a second side view, respectively, of an example embodiment of a base assembly that is used for the wheelchair and bed system 100. The various elements of the base assembly are mounted on the chassis 58.

The handles 66a and 66b are coupled with several other bar elements and the chassis to create a frame for the wheelchair and bed system 100. For example, the handle 66a is coupled with rear frame portion 130. An upper portion of the rear frame portion 130 is coupled with a portion of the frame 58. An upper end of a side bar 132 is also coupled with a portion of the frame 58. A lower portion of the rear frame portion 130 is coupled with a first end of a side bar 133. A front frame portion 131 has a lower horizontal bar that is coupled to a second end of the side bar 133 and an upper vertical bar that is coupled with a second end of the side bar 132. In a likewise fashion, the handle 66b is coupled with rear frame portion 134. A lower portion of the rear frame portion 134 is coupled with a first end of side bar 136 while an upper portion of the rear frame portion 134 is coupled to the frame 58. An upper end of side bar 137 is also coupled with the frame 58. A front frame portion 135 has a lower horizontal bar that is coupled to a second end of the side bar 136. The first frame portion comprising elements 66a and 130 to 133 is mounted to the chassis 58 via a support member 148 and the second frame portion comprising elements 66b and 134 to 137 is mounted to the chassis 58 via a support member 149.

Caster wheel 64a may be mounted to a bottom end of the vertical shaft of front frame portion 131 and secured in place with fasteners that engage apertures near the bottom portion of the vertical shaft of the front frame portion 131 and corresponding apertures on the top portion of the vertical shaft of the caster wheel 64a. Likewise, caster wheel 64b may be mounted to a bottom end of the vertical shaft of front frame portion 135 and secured in place fasteners that engage apertures near the bottom portion of the vertical shaft of the front frame portion 135 and corresponding apertures on the top portion of the vertical shaft of the caster wheel 64b. The base plate 150 is mounted to the support members 148 and 149 and the chassis 58 to provide additional structural stability. The base plate 150 may be further reinforced by mounting aluminum extrude and angle iron brackets to the underside and along the edges to ensure a more rigid base plate structure.

Leg pivot plates 144 and 145 are mounted on either side of the front portion of the frame assembly that is coupled to handle 66a while leg pivot plates 146 and 147 are mounted on either side of the front portion of the frame assembly that is coupled to handle 66b. The leg pivot plates 144 to 147 provide additional structural stability for the frame.

Plates 139, 140, 142, 143 144, 145, 146 and 147 may be fabricated from 6061-T6 plates (e.g. 10 mm thick), hand-scribed and bored via a drill-press machine. There were 2 plates used per mount. Each pair of plates was mounted so that the frame members were sandwiched between them to improve the rigidity of the base assembly during transformations between the bed and wheelchair positions. Oil-free bushings may then be mounted to these plates to help act as pivot points for both the back and leg mechanisms 47 and 154.

Frame portion 159 is mounted to the base plate 150 adjacent to a front mid portion of the chassis 58. Side support member 151 with support posts 153 and 154 at either end is mounted to the upper side bar of front frame 131 which is element 132 and upper side bar of 130 and side support member 152 with support posts 155 and 156 at either end are mounted to the upper side bar of front frame 135 which is element 137 and upper side bar of 134. One end of cross support member 158 is coupled with the support post 153 and an opposing end of the cross support member 158 is coupled with the support post 155. Likewise one end of cross support member 157 is coupled with the support post 154 and an opposing end of the cross support member 157 is coupled with the support post 156. Upper support plate 160 is mounted on top of structural members 151 to 158.

The mounts for the leg mechanism actuator 68 were coupled to support members on either side of the mounts for reinforcement which improved stability when the system 100 was in bed position.

Referring now to FIGS. 8E and 8F, shown therein is an exploded view, an isometric view, a top view, a front view and a side view, respectively, of an example embodiment of a leg assembly 154 that is used with the wheelchair and bed system 100. The leg mechanism assembly 154 is mounted to the chassis 58 of the wheelchair and bed system 100 via the same components as the back mechanism assembly 47 (e.g. oil-free bushings, shaft supports and steel shafts mounted on the backside of the leg mechanism assembly 54). A similar pivot-like mounting may also be used to couple with the arm of the leg mechanism actuator 68, by using a shaft and shaft supports.

In the example embodiment shown in FIGS. 8E and 8F, the leg mechanism assembly 54 comprises a leg mechanism plate 180, frame supports 181-184, shafts 187, 188 and 193, and fasteners 185, 186, 189, 190, 191 and 192. The leg mechanism plate 180 is mounted to the chassis 158 of the wheelchair and bed system 100 by utilizing the fasteners 185 to 190. The fasteners 191 and 192 are used to couple the leg mechanism plate 180 to the arm of the leg mechanism actuator 68. A leg cushion (not shown) or other suitable surface may be attached to the front of the leg mechanism plate 180.

The frame supports 181 to 184 are attached to the leg mechanism plate 180 and provide structural support. End portions of the frame supports 181 and 183 include C-shaped grooves spaced apart from ends of the supports 181 and 183 to receive the fasteners 185, 186, 189, and 190 as well as shafts 187 and 188 that are used to rotatably couple the leg mechanism assembly 54 to mounts on the chassis 58.

In this example embodiment, the fasteners 185 and 186 are shaft supports and the fasteners 189 and 190 are bushings. The shaft supports 185 and 186 are received within the C-shaped grooves of the frame supports 183 and 181 and are attached to the leg mechanism plate 180. The brackets 185 and 186 comprise channels that are sized to receive the shafts 187 and 188 respectively. End portions of the shafts 187 and 188 that extend from the shaft supports 185 and 186, respectively, receive inner portions of the bushings 189 and 190, respectively, such that non-flanged portions of the bushings 189 and 190 are adjacent to outer edges of the shaft supports 185 and 186 respectively and the flanged portions of the bushings 189 and 190 are adjacent to the frame of the system 100. The shafts 187 and 188 and the bushings 189 and 190 allow the leg mechanism assembly 54 to pivot when the system 100 transitions between the bed and wheelchair positions.

Also, in this example embodiment, the fasteners 191 and 192 are shaft supports that have apertures. The shaft supports 191 and 192 have prongs with apertures. The shaft supports 191 and 192 are spaced apart and receive an end of the arm of the leg mechanism actuator 68 between them. The end of the arm of the leg mechanism actuator 68 has a channel and the pin 193 is slid through the prong of the shaft support 192, through the channel of the arm of the leg mechanism actuator 68 and then through the other prong of the shaft support 191 to rotatably couple the leg mechanism assembly 54 to the arm of the leg mechanism actuator 68.

The construction and assembly of the mechanical components of the system 100 may be divided into four stages: 1) manufacture of base assembly, 2) mounting side plates to frame, 3) manufacture of leg and back assemblies and mounting to base assembly, and 4) manufacture of sliding base mechanism and mounting to base assembly.

With regards to the sliding base mechanism 56, in an example implementation, the sliders that are used are Delrin sliders (HFAFSTB6) that are sized to fit 30 mm Aluminum Extrude (e.g. element 28, 30, 31, 32, 33, 34 and 35). Elements 3 and 4 may be custom built from Aluminum for mating elements 1 and 5, and 2 and 6, respectively. Elements 5 and 6 may be 8 mm oil-free bushings (SHTNZ8-25). The shaft 7 may be an 8 mm steel shaft that is about 225 mm long (PSSFG8-225). Elements 8,9,10 and 11 may be custom built links made from Aluminum. Elements 12, 13, 24 and 27 are identical and may be Deirin sliders (HFBFSZB6) that are sized to fit 30 mm Aluminum extrude. Elements 14, 15, 16, 18, 20, 22, 25 and 26 may be 8 mm precision pins with a length of about 20 mm (CBDR8-20). Elements 17, 19, 21 and 23 may be 8 mm shaft supports (SHASS8). Elements 28 (about 255 mm long), 30 and 31 (about 115 mm long), 32 and 33 (about 255 mm long), as well as 34 and 35 (600 mm long) may all be all 30 mm Aluminum extrudes. The mounting plate 29 may be a custom built plate made from Aluminum 6061. The Aluminum angle brackets (HBLSS6) and Aluminum extrude fasteners (HNTT6-5) may be used to attach the Aluminum extrude to each other and to the elements that are used for mounting components (e.g. mounting plate 29). M5 bolts and washers may be used to fasten all components together (not shown). Elements 36, 37, 40 and 45 are carriages and elements 38 & 39 are rails (WSQ-06-30 & WJQM-01-06) that may be obtained from IGUS. Actuator 41 may be a 4 inch actuator. Element 42 is one of two shaft supports that hold element 41 in place. Elements 48 and 49 may be Al Extrude-30 mm.

In one aspect, for assembling the sliding base mechanism 56, referring to FIGS. 7C and 7D, the lower and upper shaft supports 17 and 23 and the lower and upper shaft supports 19 and 21 are mounted to the mounting plate 29. Elements 16, 18, 20 and 22 are placed into element 17. Elements 19, 21 and 23 are then placed in the same alignment as shown in FIG. 7C. Element 28 is then be fastened to the mounting plate 29. Elements 30, 31, 32 and 33 to 22, 20, 16 and 18 are then attached. The arm of the sliding base actuator 41 is then slid onto the shaft 7. Linkages 10 and 11 are then slid near a mid-portion of the shaft 7 using the lower holes and linkages 8 and 9 are slid near the mid-portion of the shaft 7 using the upper holes. Elements 34 and 35 are then mounted to the mounting plate 29. Element 1 is then attached to element 3 and element 3 is attached to element to 5 and this combination is then slid onto the left side of the shaft 7. Likewise element 2 is attached to part 4 element 4 is attached to element 6 and this combination is then slid onto the right side of the shaft 7. This subassembly is slid onto rails 34 and 35. Elements 12, 13, 24 and 27 are slid on the inside track (with respect to overall mechanism) of the posts 32, 33, 30 and 31 respectively. The hole on linkage 10 is then aligned with the hole on element 24 and the element 25 is then fastened. The hole on linkage 11 is then aligned with the hole on element 27 and element 26 is then fastened. The hole on linkage 8 is then aligned with the hole on element 12 and the element 14 is fastened. The hole on linkage 9 is then aligned with the hole on element 13 and element 15 is fastened.

Referring now to FIG. 9A, shown therein is a block diagram for an example embodiment of the electronics subsystem 200 that is used with the wheelchair and bed system 100. The electronics subsystem 200 is designed to support the automated stabilizing of the wheelchair and bed system 100 and is made up of a combination of smaller electrical components and circuits that perform specific functions.

The electronics subsystem 200 comprises a microcontroller 202 (e.g. a processor with onboard memory—not shown), a drive circuit 204, the leg mechanism actuator 68, the back mechanism actuator 46 and the sliding base actuator 41. The electronics subsystem 200 also comprises several switches that are coupled with one of the actuators 41, 46 and 68. For example, the electronics subsystem 200 comprises switches A0 and A1 that are associated with the leg mechanism actuator 68, switches B0 and B1 that are associated with the back mechanism actuator 46 and switches C0 and C1 that are associated with the sliding base actuator 41. The electronics subsystem 200 also comprises a battery 206 and a charging circuit 208.

The microcontroller 202 acts as the control center of the electronics subsystem 200 and sends commands to both the charging circuit 208 and the drive circuit 204 and receives signals from the switches A0, A1, B0, B1, C0 and C1. The microcontroller 202 may be any processing unit that comprises one or more suitable processors, controllers or digital signal processors that can provide sufficient processing power depending on the configuration, purposes and requirements of the electronics subsystem 200 as is known by those skilled in the art. In alternative embodiments, specialized hardware can be used to provide some of the functions provided by the microcontroller 202.

The microcontroller 202 typically includes a memory unit (not shown) which can be RAM or ROM or some other suitable data storage elements. The memory unit is used to store an operating system and programs as is commonly known by those skilled in the art. For instance, the operating system provides various basic operational processes for the electronics subsystem 200 while the programs are used to implement certain features such as allowing a user to control at least one of the leg mechanism actuator 68, the back mechanism actuator 46 and the sliding base actuator 41 as well as control whether the wheelchair and bed system 100 is operating in bed mode or in wheelchair mode.

The drive circuit 204 is used to maintain a stable supply of power to the actuators 41, 46 and 68 while protecting the remainder of the electronics sub-system 200. The drive circuit 204 was designed for use with 3 actuators each requiring the same nominal power.

The actuators 41, 46 and 68 may be of any suitable actuator having a size that is sufficient to provide the linear motion that is used to successfully execute the mechanical motions outlined in the sliding base mechanism 56, the back mechanism assembly 47 and the leg mechanism assembly 54.

Each pair of switches A0 and A1, B0 and B1, as well as C0 and C1 are coupled mechanically with the leg rest actuator 68, the back mechanism actuator 46 and the sliding base actuator 41, respectively, to provide signals to the microcontroller 202 when engaged by the respective actuator. These signals allow the microcontroller 202 to determine if a particular actuator is fully extended or fully contracted.

An example of the interaction between one of the actuators and a pair of switches is shown in FIGS. 9B and 9C for the leg mechanism actuator 68 and the switches A0 and A1. In this example, a circular ball is attached to the arm 68a of the actuator 68 that engages or presses (e.g. ‘clicks’) the switch A1 as the arm 68a is extended and passes by A1 causing the switch A1 to send a first actuator position indication signal indicating ‘ON’ or fully extended to the microcontroller 202. Similarly, when the arm 68a is retracted or compressed it passes by switch A0 activating the switch A0 and causing the switch A0 to send a second actuator position indication signal indicating “OFF” or fully retracted to the microcontroller 202. Accordingly, the position indication signals provided by the switches A0 and A1 communicate to the microcontroller 202 when the leg mechanism actuator 68 is fully extended (i.e. in the bed position) or compressed (i.e. in the wheelchair position). The other switches B0, B1, C0 and C1 operate in a similar fashion with the back mechanism actuator 46 and the sliding base actuator 41, respectively.

It should be noted that there may also be other switches that are not shown which are controlled by the microcontroller 202 via the drive circuitry 204 to toggle between providing and not providing power to at least one of the actuators 41, 46 and 68 in order to drive at least one of these actuators.

In an alternative embodiment, linear actuators with built-in position feedback and limit switches are used instead of having the actuators 41, 46 and 68 physically engage the corresponding switches A0 to C1.

The battery 206 may be any power storage device that may be charged via a wall power outlet and can provide an adequate amount of power for the other components of the electronics subsystem 200 to function properly.

The charge circuit 208 performs several functions including: 1) charging the on board battery 206 and 2) allowing for simultaneous charging of the battery 206 and the other electrical components of the electronics subsystem 200.

In an example implementation of this embodiment, the battery 206 is a Motomaster 12V Lead-Acid battery. A high-amp power supply unit (model: PowerPro PSU 40A) is used to handle the conversion between 120 VAC to 12 VDC and is coupled with an AC interface for charging the battery. Other batteries and power supply units may be used in other embodiments.

In an alternative embodiment, the battery 206 is implemented using a lithium-ion battery since these types of batteries have a higher energy density and a lower discharge rate whereas lead-acid batteries are heavier, and can be unsuitable for use in a hospital environment.

In an example implementation of this embodiment, the switches are provided by switch modules that consist of a MOSFET and a relay. Although mechanical relays do not switch as fast as semiconductor switches, they have a built-in electrical isolation feature which is beneficial as safety is important for the wheelchair and bed system 100. The MOSFET served as an intermediary since these mechanical relays are high-current relays that cannot be actuated by a 3.3V GPIO pin.

In an example implementation of this embodiment, the drive circuit 204 includes a motor driver which is coupled to the actuators 41, 46 and 68 via a multiplexer and drives one of the leg mechanism actuator 68, the back mechanism actuator 46, and the sliding base actuator 41 during use. A circuit breaker of suitable rating (such as 25A for example) may be added for each actuator to protect the circuitry.

In an example implementation of this embodiment, a manual switch is added after the battery 206 to serve as a “System On/Off Switch”.

The software that is run so that the wheelchair and bed system 100 properly functions is broken down into two modular components: 1) the firmware running on the microcontroller 202 which directly controls the actuators and motors and processes input from any sensors; and 2) the User Interface (UI) which registers user input and displays processed sensor data on various devices such as a smart phone with a display. The USB protocol is used to transfer data and facilitate synchronization between the firmware and the UI. In alternative embodiments, further performance improvements may be obtained by implementing a more complex communication protocol, such as full duplex over USB (and thus taking maximum advantage of the USB protocol).

Referring now to FIG. 9D, shown therein is an example of a user interface 230 that is used with the wheelchair and bed system 100. The user Interface includes 4 input buttons 232, 234, 236 and 238. The buttons 232 and 234 are used to extend or recline, respectively, the back mechanism assembly 47 and the buttons 236 and 238 are used to extend or recline the leg mechanism assembly 54. In other embodiments, other input elements such as switches, sliders or a touch screen are available to the user to provide inputs. When the user engages with the input buttons 232, 234, 236 and 238, corresponding control signals are sent to the back mechanism actuator 46 and the leg mechanism actuator 68.

Referring now to FIGS. 9E and 9F, shown therein are flowcharts of example methods 240, 250, 260 and 270 that are used to control the actuators 41, 46 and 68 of the wheelchair and bed system 100. The method 240 is operated when the user selects the input button 236 for extending the leg mechanism assembly 54 to the bed position. The method 250 is operated when the user selects the input button 238 for moving the leg mechanism assembly 54 to the wheelchair position. The method 260 is operated when the user selects the input button 232 for moving the back mechanism assembly 47 to the wheelchair position. The method 270 is operated when the user selects the input button 234 for moving the back mechanism assembly 47 to the bed position. It should be noted that in some embodiments, depending on how long the user is pressing one of the input buttons 232, 234, 236 and 238, the back mechanism assembly 47 or the leg reset assembly 54 moves to a position that is somewhere between the wheelchair and bed positions.

Referring now to FIG. 9E, when the input button 236 is selected at 242, the method 240 moves to 244 at which point the leg mechanism actuator 68 is engaged such that the actuator arm 68a extends. This extension continues to occur until the actuator arm 68a engages the switch A1 thereby causing the switch A1 to send an ON signal to the microcontroller 202 to indicate that the actuator arm 68a of the leg mechanism actuator 68 is fully extended.

Still referring to FIG. 9E, when the input button 238 is selected at 252, the method 250 moves to 254 at which point the leg mechanism actuator 68 is engaged such that the actuator arm 68a is contracted. This contraction continues to occur until the actuator arm 68a engages the switch A0 thereby causing the switch A0 to send an ON signal to the microcontroller 202 to indicate that the actuator arm 68a of the leg mechanism actuator 68 is fully contracted.

Referring now to FIG. 9F, when the input button 232 is selected at 262, the method 260 moves to 264 at which point the back mechanism actuator 46 is engaged such that the actuator arm 46a extends and the back mechanism assembly 47 rotates towards the front of the wheelchair and bed system 100. This extension continues to occur until the actuator arm 46a engages the switch B1 thereby causing the switch B1 to send an ON signal to the microcontroller 202 to indicate that the actuator arm 46a of the back mechanism actuator 46 is fully extended. At this point the method 260 proceeds to 266 at which point the sliding base actuator 41 is engaged such that the actuator arm 41a contracts and the base mechanism moves towards the rear wheels 62a and 62b of the wheelchair and bed system 100. This contraction continues to occur until the actuator arm 41a engages the switch C0 thereby causing the switch C0 to send an ON signal to the microcontroller 202 to indicate that the actuator arm 41a of the sliding base actuator 41 is fully contracted.

Still referring to FIG. OF, when the input button 234 is selected at 272, the method 270 moves to 274 at which point the sliding base actuator 41 is engaged such that the actuator arm 41a extends and the base mechanism moves away from the rear wheels 62a and 62b of the wheelchair and bed system 100. This extension continues to occur until the actuator arm 41a engages the switch C1 thereby causing the switch C1 to send an ON signal to the microcontroller 202 to indicate that the actuator arm 41a of the sliding base actuator 41 is fully extended. At this point the method 270 proceeds to 276 at which point the back mechanism actuator 46 is engaged such that the actuator arm 46a contracts and the back mechanism assembly 47 rotates away from the front of the wheelchair and bed system 100. This contraction continues to occur until the actuator arm 46a engages the switch B0 thereby causing the switch B1 to send an ON signal to the microcontroller 202 to indicate that the actuator arm 46a of the back mechanism actuator 46 is fully contracted. In an alternative embodiment, the back mechanism actuator 46 contracts at the same time that the sliding base actuator 41 extends with the back mechanism actuator 46 moving at a slower rate than the sliding base actuator 41 so that the sliding base actuator 41 has fully extended and the sliding base mechanism 56 has slid out into place before the back mechanism actuator 46 has finished contracting so that the sliding base mechanism 56 is in place to receive the back mechanism 47.

In an example embodiment, the wheelchair and bed system 100 may be about 8 inches wider than a regular wheelchair but narrow enough to fit through a standard door. The system 100 was also about 6 feet long when fully reclined to improve the comfort of the individual using the system 100. To remain mobile as a wheelchair, the actuators used by the system 100 for the transformation between wheelchair and bed positions were powered via a rechargeable battery mounted on the system 100.

In an example embodiment, the wheelchair and bed systems described in accordance with the teachings herein are designed such that it can be controlled by a mobile application that provided control of the reclining angle of the system 100 when in either bed position or wheelchair position. In this case, the electronics subsystem 200 or 400 (see FIG. 16A) further comprises a radio or other wireless communications device in order to communicate with the mobile application.

In an example embodiment, in order to preemptively identify areas of potential bed sores, the cushions of the back mechanism assembly, the seat assembly and the leg mechanism assembly of any of the embodiments herein are embedded with a pressure sensor grid that would display areas of sustained long-term pressure to the user through a mobile application.

In the example embodiments shown herein, the support members, posts and rails are made using extruded aluminum with extrude nuts which allowed for greater manufacturing tolerances as well as saving manufacturing time by eliminating the need to drill holes for mounting locations on these support members, posts and rails.

In a prototype of the wheelchair and bed system 100, it was determined that transformation between the wheelchair and bed positions may be achieved in about 30 seconds. The wheelchair and bed system was successfully transformed between the wheelchair and bed positions while supporting subjects who weighed from about 120 pounds to 250 pounds. In addition, many subjects indicated a high degree of comfort while within the wheelchair and bed system and experienced a suitable amount of granular control over the reclining level of the back and leg mechanism assemblies. Also the battery provided enough transformations to last four hours of continuous operation. Furthermore, the weight of the system was less than about 200 lbs.

Referring now to FIGS. 10A to 16D, shown therein is an example of an alternative embodiment an automated wheelchair and bed system 300 where the chassis has an alternative structure for a sliding base assembly 356. Furthermore, the automated wheelchair and bed system comprises a different height adjustment assembly 301.

Referring now to FIGS. 12G and 13B, shown therein is a view of the height adjustment assembly 301. The height adjustment assembly 301 comprises a first pairs of members 302a and 302b and a second pair of members 304a and 304b. When the system 300 is in the chair position, the first pair of members 302a and 302b are on the left side of the system 300 and the pair of members 304a and 304b are on the right side of the system 300. The two members 304a and 304b that are pivotally coupled at their centres at a pivot point 308 to provide a first scissor structure for the height adjustment assembly 301. Likewise the two members 302a and 302b are pivotally coupled at their centres at a pivot point 309 to provide a second scissor structure for the height adjustment assembly 301.

Each of the members 304a and 304b comprises a corresponding roller 306a and 306b, coupled to the front distal end of the members 304a and 304b. Each of the proximal ends of the members 304a and 304b are pivotally coupled to a lower portion 316 of the chassis and an upper portion of the chassis of system 300 (the upper portion of the chassis is a support structure to which the back assembly 147, the seat assembly 152 and the leg assembly 154 are coupled). Each of the back, seat and leg actuators are coupled to the upper chassis. In particular, the proximal end of the member 304a of the height adjustment assembly 301 is pivotally coupled to a portion of the base member 316, while the distal end of the member 304a is slidably coupled to support bars for the seat rest assembly 352. The distal end of the member 304b of the height adjustment assembly 301 has a wheel that is slidably coupled to a portion of the base member 316, while the proximal end of the member 304b is pivotally coupled to a support frame of the seat rest assembly 352 (i.e. upper portion of the chassis). The members 302a and 302b are coupled in a similar manner to the seat rest assembly 352 and the sliding base assembly 356. Please note that the terms proximal and distal are with respect to the rear of the system 300.

The members 302b and 304b are also coupled to the sliding base assembly 356 by way of actuators 312a and 312b and a horizontal member 303 (see FIG. 13B). The horizontal member 303 is coupled to the members 302b and 304b at a location above the pivot points 308 and 309, respectively. The actuators 312a and 312b have a first end that is pivotally coupled to the member 303. The actuators 312a and 312b have a second end that is pivotally coupled to a portion of the sliding base assembly 356, which is the end wall 314r of member 314. The actuators 312a and 312b provide two functions: to extend and retract a portion of the sliding base assembly 356 and to raise and lower the seat assembly 352 of the system 300 when the system 300 is in chair position and to raise and lower the seat assembly 352 (see FIG. 13B), the back assembly 347 and the leg assembly 354 when the system 300 is in bed position (see FIGS. 15C-15E. Accordingly, the actuators 312a and 312b may be referred to as base/height actuators.

The sliding base assembly 356 comprises base members 314 and 316 where base member 314 acts as a sliding base mechanism while member 316 forms part of the lower chassis. Referring now to FIGS. 12A-12D, the base member 314 comprises side members 314a and 314b, a rear member 314r and a cross member 314c. The members 314a, 314b and 314r are L shaped beams with horizontal walls that face inward and side walls that face upward. The horizontal wall of the rear member 314r is mounted on the horizontal walls of the side members 314a and 314b. The cross member 314c is a C shaped member with vertical walls where one wall spans the width of the member 314 and two walls are mounted on the horizontal side walls of the side members 314a and 314b and adjacent to the vertical side walls of the side members 314a and 314b. There are also two caster wheels 314w that are mounted near opposite end portions under the horizontal wall of the rear member 314r. There is also a pair of shaft supports 314s that is mounted on top of the horizontal wall of the rear member 314r on either side of a mid-point thereof. The pair of shaft supports 314s receives rods for coupling one end of the actuators 312a and 312b to the base member 312.

Referring now to FIGS. 12E, 14A and 14B, the base member 316 comprises two side members 316a and 316b that are both C-shaped beams where the C shape is oriented vertically. Accordingly, both side members 316a and 316b have upper and lower horizontal walls and a vertical wall that is connected to the outermost edges of the side members 316a and 316b that are the furthest away from a longitudinal midpoint of the system 300. The base member 316 comprises a front member 316f that is oriented horizontally to span the width of the base member 316. The front member 316f is an L-shaped beam with a rearwardly extending horizontal wall and a vertical upward wall at the front edge of the horizontal wall. The two side members 316a and 316b are mounted near opposite end portions on the horizontal wall of the front member 316f.

The base member 316 also comprises two lower cross beams 316s and 316t where the cross beam 316s is disposed near a mid-region of the base member 316 and the cross beam 316t is disposed near a rear portion of the base member 316. Likewise, the base member 316 comprises two upper cross beams 316cm and 316ce where the cross beam 316cm is disposed near a mid-region of the base member 316 and the cross beam 316ce is disposed near a rear portion of the base member 316 The cross beams 316s, 316t, 316cm and 316ce span the width of the base member 316 and provide structural support for the base member 316.

The members 316a and 316b act as sleeves to receive the members 314a and 314b in a reversibly slidable manner. This allows the base member 314 to slide with respect to base member 316. Accordingly, the rear member 316r of the base member 314 is coupled to one end of each of the actuators 312a and 312b while the other ends of the actuators 312a and 312b are coupled to the height adjustment assembly 301. Member 341b is a shaft support that is part of the actuator 312b while member 341a is a shaft support that is part of the actuator 312a due to the particular type of actuators that were used which were LA-28 actuators.

The base member 316 also comprises two grooves or channels 310a and 310b that are on an upper surface of the side members 316a and 316b. These grooves 310a and 310b provide rails along which the wheels at the distal end (with respect to the rear of the system 100) of the lower portion of the members 302b and 304b can slide as the system 300 transitions between bed position and chair position or to raise the height of the chair position. In a likewise fashion, the bottom surface of two side members of the seat assembly 352 comprises two grooves 307a and 307b along which the wheels at the distal end of the upper portion of the members 302a and 304a can slide as the system 300 transitions between bed position and chair position or to raise the height of the chair position.

When the automated wheelchair and bed system 300 is in the chair position, the sliding base assembly 356 is in an unextended position, the rear member 314r is at its closest point to the rear of the member 316 and the members 304a and 304b of the height adjustment assembly 302 remain at a lowest rotational point (i.e. smallest angle between ends of members). When the automated wheelchair and bed system 300 transitions from chair position to the bed position, the actuators 312a and 312b extend such that the rear member 314r is pushed away from the base member 316 and the sliding base assembly 356 moves to an extended position where the base member 314 is extended from the base member 316 (see the transition from FIG. 15A to FIG. 15B). This provides increased stability when the system is in bed mode, similar to system 100.

During the extension of the sliding base assembly 356, when the base member 314 is fully extended, the actuators 312a and 312b can continue to extend such that the height adjustment assembly 301 expands upwards since the actuators 312a and 312b expand and exert a force on the horizontal member 303 (see FIG. 13B; in this case the back and leg mechanism actuators have not been activated so the system 300 is in chair mode but elevated). Accordingly, the actuators 312a and 312b provide a dynamic force that is large enough to extend the sliding base assembly 356 backwards when a patient is being supported by the automated wheelchair and bed system 300 and also lift the back assembly 347, the seat assembly 352 and the leg assembly 354.

The required forces for the actuators 312a and 312b may be determined by first considering one of the two pairs of the members that form the scissor mechanisms, and considering only half of the lift force needed for half of the expected loads. The maximum actuator push force requirement can be determined by finding the force at the lift's lowest position as this will create the angle between one of the actuators 312a and 312b and the corresponding scissor mechanism that is least perpendicular throughout the entire system's range of motion. The two members of the scissor mechanism are then separated and analyzed as three-force members with a pin joint at the centre of both inside and outside scissor members. The static analysis for the inside scissor member has 3 externally applied forces from the load at one of the ends, from the actuator (unknown to be solved) and resultant vertical force (unknown) from the ground. The outside scissor member has the same forces without the actuator force. The resultant vertical and horizontal forces exist at the pin joint and are equal and opposite directions between the respective scissor members. One sum of moment equation is created for each member at the point that receives the reaction force from the ground (the resultant vertical forces from ground are both ignored here onwards). With two resultant forces treated as variables within two equations (one from each scissor member), the unknown actuator force can be solved. This actuator force is needed to lift half of the load and must be doubled to represent the entire lift with both scissors mechanisms if only one actuator is used. A SolidWorks model may be used to perform these calculations.

In an example embodiment, each actuator 312a and 312b is an LA-28 actuator with a push force of 3500N. Upon reaching the full extension of the bar 316, the sliding base assembly 356 remains in position due to a continued applied static force provided of the actuators 312a and 312b. This is based on assuming a force of 5943N is needed to lift a 250 lb patient while the platform for the system that is to be lifted weighs about 75 lb.

The leg assembly 354 and back assembly 347 move in the same manner as described in for the system 100. There is a leg mechanism actuator 368 that extends and retracts to rotate the leg assembly 354 from a generally vertical or slanted position when the system 300 is in chair position to a horizontal position when the system 300 is in bed position. In one example embodiment, the leg mechanism actuator 368 is an LA-28 actuator with a push force of 1500N. This allows the leg mechanism actuator 368 to provide enough static force to hold up the legs of the patient when they are lying on the system 300 and it is in bed position.

In one example embodiment, the seat actuator 368 may be an LA-28 actuator with a push force of 2000N. This allows the seat actuator to provide enough static force to hold up the mid-region of the patient when they are lying on the system 300 and it is in bed position or to lift a substantial portion of the patient's weight when the system 300 is in chair position and the height assembly 301 is actuated to raise the seat 352 (e.g. see FIG. 13B).

There is also a back mechanism actuator 346 that extends and retracts to rotate the back assembly 247 from a generally vertical or slanted position when the system 300 is in chair position to a horizontal position when the system 300 is in bed position. In one example embodiment, the back mechanism actuator 346 is an LA-28 actuator with a push force of 3000N. This allows the back mechanism actuator 346 to provide enough static force to hold up the upper torso of the patient when they are lying on the system 300 and it is in bed position.

For the back mechanism actuator 346, two point forces were used to represent the weight distribution of the patient. It was found that the head represented approximately 6.94% and the torso represented about 53.34% of the patient's total mass, respectively. The point force for the head was considered just under the eye brows and for the torso the point force was considered at the sternum. These point forces in the static analysis were approximated with respect to the layout of the system 100 in bed position. Another point force acting upwards at the exact location on the SolidWorks model where the position where the actuator shaft support lies represents the unknown vertical actuator force to be solved for. A sum of moments equation can be generated with these three forces at the hinge of the back plate. The unknown vertical force required to lift the back rest when the system 300 is in bed position can then be solved. Using the exact location and orientation of the back mechanism actuator 346 and shaft supports in the model, the angle for the back mechanism actuator 346 at the resting bed position can be determined. Using the known vertical force, known actuator angle and trigonometric identities the actuator force can be solved.

It should be noted that in other embodiments, other types of actuators may be used for any of the actuators described herein as long as the actuators provide the required static and dynamic forces and are suitable in terms of size. For example, instead of using two actuators 312a and 312b, it is possible to use a single actuator if it can provide the required dynamic and static forces as well as fit within the structural design of the system 300.

As the automated wheelchair and bed system 300 transitions from the chair position to the bed position, the actuators 312a and 312b lift the upper ends of the members 302a, 302b, 304a and 304b upwards (see the transition from FIG. 15D to FIG. 15E), thereby causing a pivotal motion of these members as the wheels (i.e. rollers) at the distal end of these members slide along the grooves 310a, 310b, 307a and 307b. As the angle between the ends of the members 304a and 304b (and likewise 302a and 302b) increases, the height of the back assembly 347, the seat assembly 352, and the leg assembly 354 is increased. Upon reaching the maximum rotation of the members 302a, 302b, 304a and 304b, the rollers remain in position by a continually applied static force of the actuators 312a and 312b.

Referring now to FIGS. 16A-16D, shown therein are electronic components and example embodiments of flowcharts that show how the system 300 operates. In particular, referring now to FIG. 16A, shown therein is a block diagram for an example embodiment of an electronics subsystem 400 that may be used with the wheelchair and bed system 300. The electronics subsystem 400 is similar to the electronics subsystem 200 in that it is designed to support the automated stabilizing of the wheelchair and bed system 300 and is made up of a similar combination of smaller electrical components and circuits that perform specific functions. The software that is run for the wheelchair and bed system 300 is also similar to system 100.

The differences for the electronics subsystem 400 and the software that is run is that it includes sliding base/height actuators 312a and 312b that are used to extend and retract the sliding base assembly 156 as well as raise and lower the seat, back and leg assemblies. Furthermore, the electronic subsystem 400 comprises a seat mechanism actuator 402 that is used to raise and lower the seat assembly. In addition, the electronic subsystem 400 comprises switches D1 and D0 that are associated with the seat assembly actuator. Switches C0 and C1 are now associated with the actuators 312a and 312b that are used to move a portion of the sliding base assembly 356 and adjust the height of the system 300 when in bed position or in chair position. The pairs of switches C0 and C1 as well as D0 and D1 are coupled mechanically with the seat rest actuator and the sliding base/height actuators 312a and 312b, respectively, to provide signals to the microcontroller 202 when engaged by the respective actuator. These signals allow the microcontroller 202 to determine if a particular actuator is fully extended or fully contracted. An example of the interaction between the actuators and the pairs of switches was shown in FIGS. 9B and 9C. As in electronics subsystem 200, there can also be additional switches (not shown) that are used to provide or remove power from the actuators.

Referring now to FIG. 16B, shown therein is an example of a user interface 430 that is used with the wheelchair and bed system 100. The user interface includes another 4 input buttons compared to the user interface 230 including input buttons 432, 434, 436 and 438. The buttons 432 and 434 are used to increasing or decreasing the angle of the seat 152 and the buttons 436 and 438 are used to raise or lower the height of the overall system 300 in either bed mode or chair mode. In other embodiments, other input elements such as switches, sliders or a touch screen are available to the user to provide inputs. When the user engages with the input buttons 232, 234, 236, 238, 432, 434, 436 and 438, corresponding control signals are sent to the seat actuator and the height actuators 312a and 312b. FIG. 14B shows two actuators where the actuator on the left is the leg mechanism actuator and the actuator on the right is the seat-angle mechanism actuator

In an alternative embodiment, a PLC system may be used with the systems 100 or 300 to route signals to different components.

Referring now to the methods that can be used to control the actuators, the methods 240 and 250 can be used with the system 300 to extend and contract the leg actuator 368. FIGS. 16C and 16D show flowcharts of example methods 440, 450, 460 and 470 that are used to control the seat actuator (methods 440 and 450) and the sliding base/height actuators 312a and 312b (methods 460 and 470) of the wheelchair and bed system 300. The method 240 is operated when the user selects the input button 236 for extending the leg mechanism assembly 54 to the bed position. The method 250 is operated when the user selects the input button 238 for moving the leg mechanism assembly 54 to the wheelchair position.

Referring now to FIG. 16C, the method 440 is operated when the user selects the input button 432 to increase the angle of the seat assembly 152. The method 450 is operated when the user selects the input button 434 for decreasing the angle of the seat assembly 152.

Referring now to FIG. 16D, the method 460 is operated when the user selects the input button 436 to extend the sliding base assembly 356 to move from chair position to bed position by sending a control signal to the actuators 312a and 312b. The method 470 is operated when the user selects the input button 438 for retracting the sliding base assembly 356 and moving to chair position by sending a control signal to the actuators 312a and 312b.

Referring now to FIG. 16E, the method 480 is operated when the user selects the input button 436 to increase the height of the system 300. The method 490 is operated when the user selects the input button 438 for decreasing the height of the system 300.

It should be noted that in some embodiments, depending on how long the user is pressing one of the input buttons 432, 434, 436 and 438, the corresponding actuators may move to a position that is somewhere between the wheelchair and bed positions and/or to a mid-height position.

It should be noted that the seat actuator can move independently of and simultaneously with the back actuator and the leg mechanism actuator.

It should be noted that for simplicity of illustration some standard components are not shown in FIGS. 10A-15E but it is understood by those skilled in the art that these components can be used in the system 300. For example, the back cushion, seat cushion and leg rest cushion can be added as well as push rails (as was shown for system 100).

It should also be noted that in some embodiments for the system 300, the arm rests can be collapsible in nature. Therefore, the arm rests can be raised (to a regular height when compared to other wheelchairs or normal chairs) or lowered (to be the same level or lower than the system's surface when in bed position). This is to assist with the lateral transfer of an individual from the system 300 to another bed-surface so that the arm rests do not get in the way.

In an alternative embodiment, the sliding base assembly can be extended using motors or a rack and pinion system. In addition, or in a further alternative, a separate drive system may be used to actuate the height adjustment assembly separately from the sliding base assembly.

In alternative embodiments for the system 300, there can be additional structural elements that can be added. For example, additional collapsible rails for the full length of the system 300 can be added for when the system is in the bed position. Alternatively, or in addition thereto, a foot-plate mechanism can be added which can also function as a railing.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments described herein, the general scope of which is defined in the appended claims.

### REFERENCES

1. Nelson, A; Baptiste, A, (2004), “Evidence-Based Practices for Safe Patient Handling and Movement, Online Journal of Issues in Nursing. Vol. 9 No. 3, Manuscript 3.
2. Waters, T; (2009). “When Is It Safe to Manually Lift a Patient?”, Online Journal of Issues in Nursing, pp. 53-57.

1. An automated wheelchair and bed system, wherein the system comprises:
a chassis;
a back mechanism assembly coupled to the chassis;
a set rest assembly coupled to the chassis;
a leg mechanism assembly coupled to the chassis; and
a sliding base assembly slidingly coupled to the chassis, the sliding base assembly comprising a sliding base mechanism that moves away from a rear portion of the system when the system transitions from a wheelchair position to a bed position and moves towards the rear portion of the system when the system transitions from bed position to wheelchair position.

2. The system of claim 1, wherein the system further comprises:
a controller for automatically controlling the transition of the system between the wheelchair and bed positions;
an input interface coupled to the controller for receiving inputs for controlling the motion of at least one of the back mechanism assembly, the leg mechanism assembly and the sliding base assembly; and
actuators coupled to the controller and the back mechanism assembly, the leg mechanism assembly and the sliding base assembly to receive at least one control signal from the controller to move at least one of the back mechanism assembly, the leg mechanism assembly and the sliding base assembly.

3. The system of claim 2, wherein the system comprises:
a back mechanism actuator that is pivotally coupled to the back mechanism assembly and the chassis;
a sliding base actuator that is pivotally coupled to the sliding base assembly and the chassis; and
a leg mechanism actuator that is pivotally coupled to the leg mechanism assembly and the chassis.

4. The system of claim 1, wherein the sliding base mechanism comprises:
an upper portion that is rotatably coupled to an arm of the sliding base actuator; and
a lower portion that is rotatably coupled to the arm of the sliding base actuator;
wherein when the arm of the sliding base actuator is extended when the system transitions to the bed position, the upper and lower portions rotate to a substantially vertical position where an upper end of the upper portion supports a portion of the back mechanism assembly and a lower end of the lower portion rests on the floor underneath the system to provide support for the system.

5. The system of claim 4, wherein the sliding base mechanism further comprises:
a horizontal shaft that is slidably received in an aperture at an end of the arm of the sliding base actuator;
a first pair of linkages that are pivotally coupled to the horizontal shaft and are pivotally coupled to the upper portion of the sliding base mechanism; and
a second pair of linkages that are pivotally coupled to the horizontal shaft and are pivotally coupled to the lower portion of the sliding base mechanism,
wherein when the arm of the sliding base actuator is extended to transition the system to the bed position, the horizontal shaft moves away from the rear of the system and the upper and lower linkages rotate to move the upper and lower portions of the sliding base mechanism to a substantially vertical position.

6. The system of claim 4, wherein the upper portion of the sliding base mechanism comprises a first set of posts with grooves and the first set of linkages are pivotally coupled to sliders that are fixed to the first set of posts and the lower portion of the sliding base mechanism comprises a second set of posts with grooves and the second set of linkages are pivotally coupled to sliders that are fixed to the second set of posts.

7. The system of claim 4, wherein the sliding base mechanism further comprises first and second set of rails that are spaced apart, have grooves and are coupled to the chassis; and opposing ends of the horizontal shaft are coupled to sliders that slidingly engage the grooves of the first and second rails.

8. The system of claim 4, wherein the sliding base mechanism further comprises a horizontal support member disposed between the upper and lower portions of the sliding base mechanism and between the first and second rails to provide additional structural support.

9. The system of claim 4, wherein sliding base mechanism comprises a base plate, the upper and lower portions of the sliding base mechanism are pivotally coupled to the base plate, and the horizontal support member is attached to the base plate.

10. The system of claim 4, wherein the lower portion of the sliding base mechanism comprises caster wheels for making contact with the floor.

11. The system of claim 3, wherein the sliding base assembly comprises a first base member that is slidably received within a lower portion of the chassis and has a retracted position during chair mode that moves to an extended position during bed mode or when the system is being increased in height.

12. The system of claim 11, wherein the system further comprises a height adjustment assembly, and at least one actuator that couples the height adjustment assembly with the sliding base assembly, the at least one actuator being configured to sequentially control the sliding base assembly and the height adjustment assembly.

13. The system of claim 12, wherein the at least one actuator is configured to move the sliding base assembly to an extended position and then increase the height of the height adjustment assembly or to decrease the height of the height adjustment assembly and then retract the sliding base assembly into a retracted position.

14. The system of claim 12, wherein the height adjustment assembly comprises a plurality of members with proximal ends that are pivotally coupled to a proximal upper portion of the chassis and a proximal lower portion of the chassis and distal ends that are slidably coupled to a distal upper portion of the chassis and a lower distal portion of the chassis.

15. The system of claim 14, wherein the height adjustment assembly comprises a first pair of members and a second pair of members, the first pair of members being pivotally coupled at their midpoint to form a first scissor mechanism disposed at one side of the system and the second pair of members being pivotally coupled at their midpoint to form a second scissor mechanism disposed at a second opposite side of the system.

16. The system of claim 15, wherein the at least one actuator is pivotally coupled to a bar that is disposed between and coupled to the first and second scissor mechanisms above the midpoint of rearward facing members that form one half of each scissor mechanism.

17. The system of claim 14, wherein the height adjustment assembly comprises a pair of rollers coupled to the distal ends of the members that are slidably coupled to the distal upper portion of the chassis where there is a downward facing groove and slidably coupled to the distal lower portion of the chassis where there is an upward facing groove, the grooves being configured to constrain the movement of the rollers in a linear fashion.

18. The system of claim 3, wherein the system further comprises a seat actuator that is pivotally coupled to an upper portion of the chassis for adjusting the angle of the seat rest.
